(19) United States
(12) Patent Application Publication
(10) Pub. No.: US 2024/0330976 A1
(43) Pub. Date: Oct. 3, 2024

(54) REPRESENTATIVE SAMPLING SYSTEM AND METHOD FOR PEER ENCOURAGEMENT DESIGNS IN NETWORK EXPERIMENTS

(71) Applicant: UNIVERSITY OF SOUTHERN CALIFORNIA, Los Angeles, CA (US)

(72) Inventors: Sha Yang, Los Angeles, CA (US); Yanyan Li, Los Angeles, CA (US); Qing Liu, Madison, WI (US)

(73) Assignees: UNIVERSITY OF SOUTHERN CALIFORNIA, Los Angeles, CA (US); Wisconsin Alumni Research Foundation, Madison, WI (US)

(21) Appl. No.: 18/622,610

(22) Filed: Mar. 29, 2024

Related U.S. Application Data
(60) Provisional application No. 63/455,910, filed on Mar. 30, 2023.

(51) Int. Cl. G06Q 30/0242; G06F 9/451; G06Q 50/00; H04L 67/50

(52) U.S. Cl. CPC G06Q 30/0242; G06F 9/451; G06Q 50/01; H04L 67/535

(57) ABSTRACT

Systems, computer-readable medium, methods and apparatus, and/or devices to causally quantify the potentially heterogeneous direct effect of a marketing program on focal individuals (e.g., egos) and the indirect effect on those connected to the focal ones (e.g., alters). A primary data structure (focal individual or ego) may be connected to multiple secondary data structures (alters) by a primary-to-secondary linkage net. Moreover, different secondary data structures may be connected together by a secondary-to-secondary linkage net, and some secondary data structures maybe connected to multiple primary data structures. Thus, in a complicated arrangement of connections, an input change directed at a single primary data structure may have both direct effects thereon, and complex indirect effects on secondary data structures. The systems, computer-readable medium, methods and apparatus, and/or devices provide mechanisms to evaluate these effects.

### CROSS REFERENCE TO RELATED APPLICATIONS

This application is based upon and claims the benefit of and priority to U.S. Provisional Patent Application No. 63/455,910 entitled “REPRESENTATIVE SAMPLING METHOD FOR PEER ENCOURAGEMENT DESIGNS IN NETWORK EXPERIMENTS,” filed on Mar. 30, 2023, the entire content of which is incorporated by reference herein.

### STATEMENT AS TO FEDERALLY SPONSORED RESEARCH

Not applicable.

### BACKGROUND

### 1. Field

The following disclosure relates to sampling algorithms, and more specifically, to sampling algorithms in network experiments.

### 2. Description of the Related Art

Targeted marketing interventions are prevalent on social networks, ranging from referral campaigns to social advertising. Firms are increasingly interested in conducting network experiments through peer encouragement designs to causally quantify the potentially heterogeneous direct effect of a marketing program on focal individuals (e.g., egos) and the indirect effect on those connected to the focal ones (e.g., alters). A widely adopted practice to obtain clean estimates of the direct and indirect treatment effects in peer encouragement designs is to draw random samples from the population network and then exclude contaminated egos and alters (e.g., those in the treatment group and those in the control group having a relationship) from the inference. However, this approach may lead to underrepresentation and undersupply of the resulting treatment/control samples, which have been documented in the literature as two major technical challenges in conducting network experiments with peer encouragement designs. While underrepresentation indicates the samples' lack of representation of the population characteristics leading to biased inferences of the treatment effects and limited generalizability, undersupply pertains to small sample sizes resulting in low statistical power and experimental efficiency.

### SUMMARY

A representative sampling system for peer encouragement designs in network experiments is provided. The system may include one or more non-transitory computer-readable storage devices. The device(s) may be configured to store computing instructions configured to run on one or more processors. The device(s) may be configured to store interactions with a first customized GUI. The system may include one or more processors configured to run the computing instructions. The processor(s) may perform generating the first customized GUI. The processor(s) may perform tracking the interactions with the first customized GUI. The processor(s) may perform sampling the interactions. The processor(s) may perform generating a second customized GUI based on the sampling. The second customized GUI being different from the first customized GUI.

In various embodiments, the tracking the interactions includes tracking views of the first customized GUI or shares of the first customized GUI on a social network. In various embodiments, the sampling the interactions includes using a predictive algorithm to sample the interactions. In various embodiments, the using the predictive algorithm includes generating a Markov chain of interactions. In various embodiments, the using the predictive algorithm includes implementing a Bayesian sampling algorithm. In various embodiments, the predictive algorithm is a Metropolis-Hastings algorithm.

In various embodiments, the sampling the interactions includes generating noncontaminated treatment samples and noncontaminated control samples. The noncontaminated treatment samples and the noncontaminated control samples may have no first-degree contamination. The noncontaminated treatment samples and the noncontaminated control samples may have no first-degree contamination and/or no second-degree contamination.

The one or more processors may be further configured to perform, after the tracking the interactions, generating an ego network using the interactions. The sampling the interactions may include sampling representative ego networks from the population network. In various embodiments, the generating the first customized GUI includes generating a customized social media website for a plurality of users.

A representative sampling method for peer encouragement designs in network experiments is provided. The method may be implemented via execution of computing instructions configured to run at one or more processors and configured to be stored at non-transitory computer-readable media. The method may include generating, using the one or more processors, a first customized GUI. The method may include tracking, using the one or more processors, interactions with the first customized GUI and storing the interactions in the non-transitory computer readable media. The method may include sampling, using the one or more processors, the interactions. The method may include generating, using the one or more processors, a second customized GUI based on the sampling.

In various embodiments, one or more further aspect is provided. For example, the tracking the interactions may include tracking views of the first customized GUI or shares of the first customized GUI on a social network. The sampling the interactions may include using a predictive algorithm to sample the interactions. The using the predictive algorithm may include generating a Markov chain of interactions. The using the predictive algorithm may include implementing a Bayesian sampling algorithm. The predictive algorithm may include a Metropolis-Hastings algorithm. The sampling the interactions may include generating noncontaminated treatment samples and/or noncontaminated control samples. The noncontaminated treatment samples and the noncontaminated control samples have no first-degree contamination and/or no second-degree contamination.

The method may include further aspects. The method may include, after the tracking the interactions, generating an ego network using the interactions. The sampling the interactions may include sampling ego networks from the population network. The generating the first custom GUI may include generating a customized social media website for a plurality of users.

An electronic system is provided to determine relationships between electronic data objects. The system may include a primary data object data store. The system may include a secondary data object data store. The primary data object may include a function having a primary data object input and a primary data object output. The secondary data object may include a secondary function having a secondary data object input and a secondary data object output. The system may include a linkage net calculator. The linkage net calculator may be configured to measure an effect on a secondary data object output value of at least one secondary data object responsive to at least one of a primary data object value of a primary data object or a change in the primary data object value of a primary data object. The linkage net calculator may be configured to generate a linkage net including a linkage data object with values corresponding to identified effects and corresponding one or more secondary data objects and corresponding one or more primary data objects corresponding to the identified effects.

In various embodiments, the linkage net includes (1) a field identifying the primary data object having the primary data object input that has an effect on the secondary data object output and (2) a function characterizing the effect.

The electronic system may include a secondary data object linkage net calculator configured to measure an effect on (x) a further secondary data object output value of at least one further secondary data object (y) responsive to at least one of the secondary data object value of the secondary data object or a change in the secondary data object value of the secondary data object. The secondary data object linkage net calculator may be configured to generate a secondary data object linkage net including a secondary linkage data object with values corresponding to identified effects and corresponding to one or more secondary data objects and corresponding one or more further secondary data objects corresponding to the identified effects.

The primary data object data store may be a computer memory. The secondary data object data store may be the computer memory. The linkage net calculator may be a processor. The primary data object may be a data object corresponding to an internet account publishing at least one of text and/or photos to a website. The primary data object may include a data object corresponding to another internet account publishing at least one of text and/or photos in response to the primary data object. In various embodiments, the primary data object input includes text or images present on the internet and the secondary data object input includes text and/or images output onto the internet by the primary data object. Moreover, the secondary data object output may include text and/or images output by the secondary data object on the internet.

In various embodiments, the primary data object store includes a repository of primary data objects corresponding to accounts publishing content on the internet. In various embodiments, the secondary data object store includes a repository of data objects corresponding to accounts accessing the published content on the internet published by the primary data objects. The linkage net calculator may be a processor running a predictive algorithm comprising a Metropolis-Hastings algorithm, to measure the effect.

A linkage display object is provided. The linkage display object may be structured to generate a human-readable screen display image for viewing on a human-readable screen display. The human-readable screen display image may have visual elements corresponding to values of the linkage display object. The linkage display object may include a linkage net calculator. The linkage net calculator may be configured to perform various tasks.

For instance, the linkage net calculator may (i) measure an effect on a secondary data object output value of at least one secondary data object responsive to at least one of a primary data object value of a primary data object or a change in the primary data object value of the primary data object. The primary data object includes a function having a primary data object input and a primary data object output. The secondary data object includes a secondary function having a secondary data object input and a secondary data object output.

The linkage net calculator may (ii) generate a linkage net including the linkage data object with values corresponding to identified effects corresponding to one or more secondary data objects and one or more primary data objects.

A method is provided. The method may be a method of quantifying heterogenous direct effects of data input and output relationships among data objects by a system. The system may include (i) one or more non-transitory computer-readable storage devices configured to store computing instructions configured to run on one or more processors and store interactions with a first customized GUI. The system may include (ii) one or more processors configured to run the computing instructions, the one or more processors performing the method. The method may include generating the first customized GUI including data objects comprising the data input. The method may include tracking the interactions with the first customized GUI. The method may include sampling the interactions. The method may include generating a second customized GUI based on the sampling. The second customized GUI may include further data objects. The further data objects may correspond to the direct effects.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates a peer encouragement design with a binary treatment, in accordance with various embodiments;

FIG. 2 illustrates a chart plotting the number of remaining ego networks in each treatment condition under various initial sample sizes for an excluding method, in accordance with various embodiments;

FIGS. 3A-3F plot a posterior distribution of individual treatment effect parameters and the spillover parameter estimated using representative samples and baseline samples, in accordance with various embodiments;

FIGS. 4A-4C plot predicted individual treatment effects for individuals in a population based on estimates from representative samples and from baseline samples, in accordance with various embodiments;

FIG. 5 depicts an illustration of symmetry proposal distribution under constraint, in accordance with various embodiments;

FIG. 6A illustrates KS distance with increasing sample sizes, in accordance with various embodiments;

FIG. 6B illustrates sample size after excluding contaminated nodes in a dense network, in accordance with various embodiments;

FIG. 7A shows a power of average direct treatment effects (egos), in accordance with various embodiments;

FIG. 7B shows a power of average indirect treatment effects (alters), in accordance with various embodiments;

FIGS. 8A-8C illustrates an example computing system to perform the methods, in accordance with various embodiments;

FIG. 9 illustrates aspects of an example linkage net calculator, in accordance with various embodiments;

FIGS. 10A-10C illustrate a method of determining relationships between electronic data objects, in accordance with various embodiments; and

FIG. 11 illustrates a method of determining relationships between electronic data objects implemented in a graphical interface of a computing system, in accordance with various embodiments.

### DETAILED DESCRIPTION

Targeted marketing interventions are prevalent on social networks, ranging from referral campaigns to social advertising. Firms are increasingly interested in conducting network experiments through peer encouragement designs to causally quantify the potentially heterogeneous direct effect of a marketing program on focal individuals (e.g., egos) and the indirect effect on those connected to the focal ones (e.g., alters). A widely adopted practice to obtain clean estimates of the direct and indirect treatment effects in peer encouragement designs is to draw random samples from the population network and then exclude contaminated egos and alters (e.g., those in the treatment group and those in the control group having a relationship) from the inference. However, this approach may lead to underrepresentation and undersupply of the resulting treatment/control samples, which have been documented in the literature as two major technical challenges in conducting network experiments with peer encouragement designs. While underrepresentation indicates the samples' lack of representation of the population characteristics leading to biased inferences of the treatment effects and limited generalizability, undersupply pertains to small sample size resulting in low statistical power and experimental efficiency.

This disclosure provides a Bayesian representative sampling algorithm to improve the peer encourage designs and the related causal inference by addressing the underrepresentation and undersupply problems.

The resulted samples from the proposed method not only better represent the population on individual network properties and personal characteristics that may drive heterogeneous responses to treatment, but also have a larger sample size to assist proper statistical inference and testing. Simulations show that, compared with those obtained from the post-hoc “excluding” approach, samples constructed based on this proposed method allow researchers to more precisely estimate the average treatment effects and the heterogeneity in individual treatment responses and predict the treatment effects out of sample. Moreover, the proposed representative sampling method is demonstrably computationally efficient and can be conveniently adapted and incorporated into many applications for evaluating social influences.

With the continuing growth and expansion of social media, targeted marketing interventions are becoming prevalent on social networks, ranging from referral campaigns to social advertising. As a motivating example, consider a social networking firm (e.g., LinkedIn) promoting its premium service to a targeted group of individuals on the platform to encourage subscription. The effectiveness of the campaign, not surprisingly, will be affected by responses from the targeted individuals (e.g., the direct or own effect). In addition, the campaign may influence those who are connected to the targeted ones (e.g., the indirect or social effect), as their subscription decision may be indirectly influenced by those who are directly exposed to the campaign. Therefore, to maximize the overall return of the marketing investment, the firm needs to consider both the direct and the indirect effect in selecting the targeting group. To do so, the firm runs pilot studies to explore which subpopulations are more likely to respond to the promotion and subscribe, to what extent these subpopulations would influence their connections' subscription decisions, and the predicted ROIs of alternative campaigns targeting different types of potential customers.

Researchers often run field experiments with peer encouragement designs to estimate the direct and indirect effects of targeted marketing campaigns on social networks. In such case, ego networks are randomly sampled and assigned to treatment and control conditions, respectively. Each ego network consists of a focal individual (e.g., the ego) and those connected to the ego (e.g., the alters), and treatment is only given to egos in the treatment group. Inference is then made by analyzing response differences of the egos in treatment and control conditions to estimate the direct treatment effect, and response differences of the alters in the two conditions to estimate the indirect treatment effect.

To avoid treatment contaminations in peer encouragement designs, which occur when treated and control egos are directly connected and/or an alter is connected to multiple egos, the conventional approach is to randomly draw ego-network samples to assign to the treatment/control conditions but only use those non-contaminated ego networks to estimate the direct and indirect treatment effects (hereafter referred to as the excluding approach). However, the excluding approach has two potential issues.

The first one is the sample underrepresentation. The remaining samples after excluding those invalid ego networks tend to be homogeneous or underrepresent the population. For example, high-degree individuals (e.g., those with many connections) are more likely to be contaminated and thus removed from the analysis. Due to underrepresentation of the treatment/control samples, experimental findings cannot be generalized to the population when treatment effects are heterogeneous depending on how well individuals are connected with others.

The second one is the undersupply issue, that is, the “cleaned” sample after excluding the contaminated units can be too small to achieve a desirable statistical precision and power in estimating any heterogeneous treatment effect. In practice, one has to run an experiment with a large sample of ego networks to start with in order to obtain reasonable-sized uncontaminated or qualified ones for inferences. The initial large sample is inefficient and can substantially raise the cost if the treatment involves monetary incentives.

This research proposes a Bayesian representative sampling method to draw ego networks in peer encouragement designs for inference and testing of the direct and indirect treatment effects of a targeted marketing intervention on social networks. The proposed ego-network sampling algorithm directly addresses the underrepresentation and undersupply issues and has two major advantages over the traditional excluding algorithm.

First, it allows researchers to draw treatment and control samples that represent the population network such that the joint distribution of the variables for sampled individuals converges to the joint distribution of these variables for the population. In particular, it focuses on individual network properties such as degree and clustering coefficient that have been found in many cases to affect how individuals respond differently to a targeting campaign. The obtained representative samples allow for more precise estimation of the heterogeneous treatment effects and generalizability of the experimental findings to the population at large.

Second, when drawing representative treatment and control samples, the proposed method proactively controls for treatment contaminations in the sampling process by embedding constraints in the algorithm to avoid any overlapping between the sampled ego networks, allowing one to obtain larger valid samples for causal inference. Taken together, this provides a powerful and efficient sampling method to generate representative and sizable treatment and control samples to assist causal inferences in network experiments with peer encouragement designs.

This disclosure discusses the conduct of simulations on a power-law cluster network, widely observed in the real world, to compare the performance of the method with the excluding method. For the proposed algorithm, things considered include two individual network properties, degree and clustering coefficient, in drawing ego networks in both treatment and control conditions. This disclosure finds that the obtained ego-network samples better represent the population on these two network properties as well as other personal characteristics correlated with the two, compared with those obtained from the excluding approach. Meanwhile, the obtained samples are not less representative on other variables not considered in the sampling procedure. Moreover, one can flexibly specify the size of a qualified sample at priori, and in general, the method allows one to obtain larger valid ego-network samples.

The disclosure also demonstrates the superior performance of the samples obtained from the proposed method (“representative samples”) relative to samples from the excluding method (“baseline samples”) in estimating the treatment effects. One may consider a network experiment with the peer encouragement design for testing a targeted intervention, in which egos (“primary data objects”) such as treated egos respond to the treatment and also influence their alters (“secondary data objects”) heterogeneously according to the egos' network properties and personal characteristics. At the aggregate level, the representative samples produce more accurate and precise estimates of the average direct and indirect treatment effects. At the subpopulation level, representative samples allow the system to more accurately recover the true parameters determining how the heterogeneous treatment effects are related to individuals' network properties and personal characteristics, and thereby provide more precise out-of-sample prediction of treatment effects on individuals in the population, especially on those high-degree individuals who are difficult to be sampled in a power-law network.

This disclosure makes important contributions. First, this disclosure proposes a representative sampling method to address the underrepresentation and undersupply issues in network experiments with peer encouragement designs, and these issues are difficult to address with the conventional excluding approach. The obtained representative samples are shown to improve the accuracy and power of the causal inference for the average direct and indirect treatment effects. Peer encouragement designs have been widely adopted by academics and practitioners in various marketing contexts, such as viral marketing, music subscription, user feedback, CRM campaign, and churn management. However, how to generate representative ego-network samples while controlling for treatment contaminations has largely remained as a “methodological limitation” for the commonly used ego-network randomization approach in peer encouragement designs. This disclosure directly addresses this methodological challenge.

Second, the proposed method provides representative and qualified samples to facilitate accurate inference of the heterogeneous treatment effects among subpopulations in peer encouragement designs. There has been a growing interest in understanding what constitutes the underlying heterogeneity in individuals' direct responses to a treatment and/or influences on social connections. The proposed method can be especially useful in providing high-quality samples to help answer questions about what individual characteristics may affect the direct and indirect treatment effects of targeted marketing campaigns on social networks, and whether the uncovered heterogeneous treatment effects from the samples can be generalized to the population.

The disclosure provides a review of peer encouragement designs in network experiments to provide background information and further highlight the contributions herein. The disclosure introduces a proposed representative ego-network sampling method. The disclosure demonstrates that the proposed method produces samples that are more representative of the population network and are larger in size than the excluding method. The disclosure illustrates the superiority of the representative samples in estimating the direct and indirect treatment effects and the underlying heterogeneity. The disclosure concludes with discussions of potential extensions of the method to other applications.

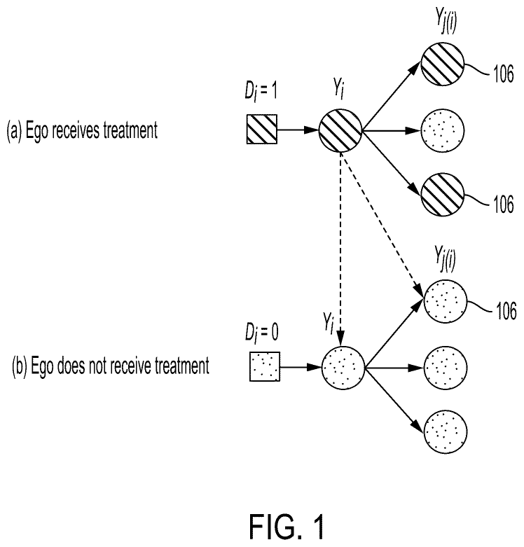

The discussion will now focus on peer encouragement designs for network experiments, such as peer encouragement designs and the corresponding causal inference. Peer encouragement designs are commonly used in network experiments to test the direct treatment effect on targeted individuals (e.g., egos) and the indirect treatment effect on those connected to the targeted individuals (e.g., alters). Under this design, egos are randomly assigned to the treatment condition to receive the targeting intervention (dᵢ=1) which would change their behaviors Yᵢ, or the control condition without receiving the treatment (dᵢ=0). Each ego defines an ego network which includes the ego i itself and alters j's (e.g., immediate connections of the ego). Although alters do not receive the treatment, in the treatment condition, their behavior Y can be indirectly affected by the exogenous treatment dᵢ given to the connected ego i. FIG. 1 illustrates a peer encouragement design with a binary treatment. In the treatment condition illustrated in (a), the targeting intervention encourages the ego to change his/her behavior, which in turn causes two alters to change their behaviors. Let Yᵢ(dᵢ, d₋ᵢ) denote the potential outcome for individual i, and it depends on his/her own treatment status dᵢ and immediate connections' treatment status d₋ᵢ where we use −i to indicate all individuals in the same ego network other than i. This setup allows the system to estimate the direct and indirect treatment effects of an interest, based on the potential outcomes of egos and alters.

Direct Treatment Effect (DTE) is defined as the effect of the treatment on the directly treated individuals. Under the peer encouragement design outlined above, the potential outcome for ego i becomes Yᵢ(dᵢ, 0) because none of i's immediate connections are treated. Hence, DTE is formulated as the difference in egos' potential outcomes Yᵢ with and without the treatment,

$${τ}_{i} = {Y}_{i} ( {d}_{i} = 1 , {d}_{- i} = 0 ) - {Y}_{i} ( {d}_{i} = 0 , {d}_{- i} = 0 ) . \qquad ( 1 )$$

Indirect Treatment Effect (ITE) is defined as the effect of the treatment on individuals who are not treated but are connected to the treated ones. For alters j of ego i, dⱼ=0 because they do not receive the treatment themselves. However, they may receive indirect treatment d₋ⱼ=dᵢ from ego i. In particular, d₋ⱼ=1 when alters are connected to a treated ego and d₋ⱼ=0 when they are connected to a control ego. Therefore, the ITE can be identified by contrasting the behaviors of alters connected to the treated and control egos,

$${γ}_{j} = {Y}_{j} ( {d}_{j} = 0 , {d}_{- j} = 1 ) - {Y}_{j} ( {d}_{j} = 0 , {d}_{- j} = 0 ) . \qquad ( 2 )$$

The discussion now turns to treatment contamination and the commonly used solution. Peer encouragement designs, like many other network experimental designs, are prone to treatment contaminations. As illustrated in FIG. 1, contaminations could occur if two egos are directly connected or share one or more common friends (shown by the dotted arrows), leading to the violation of the Stable Unit Treatment Value Assumption (SUTVA). For example, when ego i's neighbors contain one or more treated ego(s), the estimation of the DTE is biased since d₋ᵢ≠0. Similarly, when alter j is connected to multiple egos, the estimation of the ITE is biased since the indirect treatment d₋ⱼ≠dᵢ. In sum, two conditions need to be satisfied to minimize treatment contaminations. First, there should be no first-degree contamination, that is, any two sampled egos, within or across treatment conditions, are not directly connected, to facilitate clean estimation of the DTE. Second, there should be no second-degree contamination, that is, any two sampled egos, within or across treatment conditions, do not share a common alter, to facilitate clean estimation of the ITE.

The most widely used approach to minimize treatment contaminations is to exclude the contaminated individuals from the random sample and only use the non-contaminated ones for causal inference. Despite its simplicity, this approach faces two challenges. The first one relates to the underrepresentation, that is, the “cleaned” sample may not be representative of the population network. Intuitively, if the treatment effects are heterogeneous across subpopulations, the underrepresentation of the treatment/control samples may lead to biased estimates of the treatment effects, and the generalizability of experimental findings is at question. For example, the “excluded users who are friends of both the treated and control group are not random since high-degree individuals are more likely to be friends of both groups.” Excluding the intersection concerns the generalizability of the findings to high-degree users and is a “difficult and not yet solved problem in network experiments.” Similarly, excluding the contaminated alters may reduce the heterogeneity in the sample. Populations receiving different types of indirect exposure to treatment (e.g., alters who connect to multiple egos) may be fundamentally different from the representative population at large.

The second challenge relates to undersupply, that is, excluding contaminated samples may leave small, qualified samples to work with, reducing the precision and power of statistical inference and testing. Moreover, inferences on the heterogeneous treatment effects (e.g., how the treatment effects differ across different groups of individuals) can be challenging since some subpopulations may not appear in the treatment/control samples. Understanding how different subpopulations respond to treatment is particularly important for marketers to develop effective targeted strategies. Prior research has demonstrated that individuals in different network positions (e.g., degree) may respond differently to interventions and exert different social influences on others. Another stream of research found that individuals' personal characteristics, such as demographic variables, can explain how influential or susceptible subpopulations are.

One may wonder how serious the treatment contaminations would be in real-world field experiments, in which the size of population networks could be as large as millions of users and the sample sizes are just a few thousands. Admittedly, prior research has reported that the number of samples removed is generally less than 5%. However, this could still limit an understanding about the rare yet influential high-degree individuals. Moreover, researchers may not always have the opportunity to conduct experiments on such a large population network. For instance, for pilot studies where treatment is costly or risky, companies may want to test marketing interventions on a relatively small network. As shown in simulations, when the size of the population network is not as large or the network is dense, treatment contaminations are more likely to happen even for a small sample size. This disclosure proposes a representative sampling method to directly address the two challenges. Using the proposed method, the system may generate representative and clean ego-network samples to facilitate estimation of the direct and indirect treatment effects in peer encouragement designs.

The discussion is now directed to the proposed representative ego-network sampling method, and specifically, the theoretical framework. In peer encouragement designs, the sampling unit is ego network, consisting of an ego and all the alters of the ego. Let G denote the set of all individuals in the population network, S_{d} be the set of n_{d} egos for treatment condition d∈D and S_{D}={S_{d}}_{d} the set of egos for all treatment conditions in D. Let A(i) denote the set of alters of ego i, A(S_{d}) the set of all alters for treatment condition d, and A(S_{D}) the set of all alters for all conditions in D.

Denote f(P) the distribution of a network property f (e.g., degree) for individuals in set P. Define Δ to be a distance measure on two distributions. For instance, Δ(f(S_{d}), f(G)) represents the distance between the distributions of network property f in the sampled egos S_{d} and in the population G. Following the spirit of representative sampling, one may obtain ego-network samples that represent the population in terms of property f, by finding S_{d} for each treatment condition d from G that minimizes the objective function Δ(ƒ(S_{d}), ƒG).

Moreover, the system may impose constraints on the sampled ego networks to minimize treatment contaminations. Recall that two identification conditions suggest no first-degree contamination (e.g., any two sampled egos, within or across treatment conditions, are not directly connected) or second-degree contamination (e.g., any two sampled egos, within or across treatment conditions, do not share a common alter) among sampled egos S_{D} in all treatment conditions. These constraints are added to the objective function. The constrained optimization is then formulated as:

$$arg {min}_{{S}_{d} ⊆ G} Δ ( f ( {S}_{d} ) , f ( G ) ) \qquad ( 3 )$$

$$subject to i ∉ A ( {i}^{′} ) and A ( {i}^{′} ) ⋃ A ( {i}^{′} ) = ∅ , for i , {i}^{′} ∈ {S}_{D} , and i \neq {i}^{′} . \qquad ( 4 )$$

Three important notes regarding the representative sampling method are in order. First, the difference between the sample and the population distributions as specified in the objective function in (3) can be based on one or multiple variables that explain individual heterogenous responses to a targeting campaign. In simulation studies, the discussion focuses on two important network properties (e.g., individuals' degree and clustering coefficient) so that the sample is representative of the population in terms of the distributions of these two variables. The first variable is degree (e.g., the total number of immediate connections a person has). Degree is a measure of an individual's local influence to or from others, and therefore is highly relevant for measuring individual's response to a targeted intervention and social influence. The second variable considered is clustering coefficient, which measures the likelihood that a person's friends are also friends. The clustering coefficient Cᵢ is calculated as the fraction of possible triangles (e.g., a group of friends of three) through the focal individual i,

$${C}_{i} = \frac{2 T ( i )}{{K}_{i} ( {K}_{i} - 1 )} ,$$

where T(i) is the number of triangles through individual i, and Kᵢ is the individual degree. Because unobserved correlation or similarity (e.g., homophily) within the local ego networks could exist regardless of exogenous treatments, by incorporating clustering coefficients in the objective function, the sampling method ensures that the local network structure of the sampled ego networks is representative of that of the population and that the samples for each treatment condition are well balanced in terms of their local network structures.

Second, the objective function requires a measure to quantify the distance between the population and sample distributions of the variables of focal interest. The system may use the Kolmogorov-Smirnov (KS) Statistics which corresponds to the maximum absolute difference between the two cumulative distribution functions (CDFs) F_{G} of f(G) and F_{S}_{_{d}} of f(S_{d}),

$$Δ ( f ( {S}_{d} ) , f ( G ) ) = {max}_{i ∈} \vert {F}_{G} ( i ) - {F}_{{S}_{d}} ( i ) \vert , \qquad ( 5 )$$

where [symbol] is the set of all possible values of network property f.

One advantage of this measure, compared to alternative measures such as the Kullback-Leibler divergence, is that it can be computed for any pair of distributions regardless of their support. For example, when a group of individuals is sampled from the population, the support of the degree distribution in the sample is very likely to be smaller than that in the population and varies across different samples. In the case that multiple variables are considered in the objective function, the system may compute the distance based on the joint distribution of these variables. For instance, for the degree (variable 1) and the clustering coefficient (variable 2), the system may first compute the joint distributions of the two variables in the population and in the sampled egos, denoted as f_{1,2}(G) and f_{1,2}(S_{d}), respectively. Then, the KS distance can always be computed by taking the maximum absolute difference between the two joint CDFs, Σ_{1,2}(G) and Σ_{1,2}(S_{d}), for the population and the sample, respectively.

Third, the system may explicitly control for the overlapping between egos, that is, the system may eliminate first- and second-degree contaminations (e.g., the distance between two egos is at least 3 hops apart). Admittedly, treatment contaminations could go beyond first- and second-degree. However, this is a reasonable assumption because the information flows between individuals in a network typically decay rapidly with network distance. In practice, researchers can further space away two sampled egos if treatment contamination is believed to go beyond two hops. In other applications where treatment contamination is not believed to be severe, researchers could consider loosening the constraint, for instance, allowing for certain second-degree connections among egos, as long as treatment effect estimation and inference will not be affected by the connections when kept below a threshold.

The discussion continues, shifting now to the representative sampling algorithm. Solving the constrained optimization problem in (3) and (4) is hard and intractable. It is a high dimensional optimization problem involving optimal choice of many ego networks under constraints. Furthermore, the objective function can involve multiple variables, which further complicates the optimization procedure. The system may use the Metropolis-Hastings (MH) algorithm to find solutions to the constrained optimization problem.

The Metropolis-Hastings algorithm is a sampling technique based on Markov Chain Monte Carlo (MCMC) methods. It is one of the most important sampling methods for Bayesian estimation. In the subgraph sampling literature, researchers have applied the MH algorithm to modify the transition probabilities of Random Walk methods to collect more uniformly distributed nodes from a large graph. An algorithm may be proposed to sample an induced subgraph (a graph consists of sampled nodes and edges only between the sampled nodes) such that the network properties of the induced subgraph can represent the properties of the original graph.

The system may propose a representative sampling method for peer encouragement designs for network experiments to improve the quality of the treatment and control samples and the corresponding causal inference based on the obtained samples. The method has three unique features. First, while the goal of subgraph sampling methods is to obtain an induced subgraph to reduce the computational burden of working with the large graph, the method aims to improve causal effects estimation and inferences in network experiments by providing a sampling algorithm to produce representative and noncontaminated treatment and control samples. Second, the method takes a different view on sample representativity. While the subgraph sampling is interested in representation of the sampled units' network properties measured with respect to the induced subgraph, the method focuses on representation of the sampled units' network properties measured with respect to the population as the goal is to provide treatment and control samples so that results based on sampled individuals can be generalized to those in the population. Third, the performance of the method is evaluated on not only to what extent the samples represent the population, but also how accurately the produced samples can estimate and predict the treatment effects.

Next, this discussion considers the Metropolis-Hastings algorithm. The discussion will first briefly discuss the main idea of the MH algorithm in the application. From a statistical point of view, the ego-network sampling is to draw a set S of n nodes as egos (S represents the set of egos S_{d} for any treatment assignment d; for simplicity, the subscript d is omitted) from the total N nodes of the population G. For the random ego-network sampling, the egos S are uniformly distributed on the sample space [symbol] ={S⊂G∥S|=n}. In contrary, the sampling method draws egos S from the sample space [symbol] following a desired probability P(S) (e.g., a target distribution) such that samples S that are representative of the population should be drawn more frequently than those are not. An obvious choice of P(S) is an unnormalized density that is inversely proportional to the distance measure between the sample S and the population G on a predefined list of variables. Though the exact distribution of P(S) is unknown, the system may approximate P(S) by π(S) which is defined as the inverse of the distance measure in (5):

$$π ( S ) = \frac{1}{{Δ ( f ( S ) , f ( G ) )}^{p}} , \qquad ( 6 )$$

so π(S) is inversely proportional to the desired distribution P(S).

Note that, given the huge search space, the system may add a positive scalar

$$p = 10 \cdot \frac{k}{N} {log}_{10} N ,$$

where k is the number of total edges and N is the total number of nodes of the population network, to reward good samples such that lower-quality samples would not dominate the sampling process. The system may use the MH algorithm to design a Markov chain with the sample space [symbol] as its state space and P(S) as the desired stationary distribution which is approximated by π(S). Next, the discussion describes the details of the MH algorithm.

For the Markov chain to achieve the stationary distribution P(S), the discussion may start by specifying the transition probability Q (S′|S) which is the probability of transitioning from current state S to a future state S′. In various cases, each state is a sample S with n nodes (as egos). Note that two conditions related to the transition probability are required for the Markov chain to converge: (1) ergodicity, which requires that any state is reachable by any other state in a finite number of transitions; (2) detailed balance, which requires that for a pair of states (S,S′), the probability of being in state S and transitioning to state S′ must be equal to the probability of being in state S′ and transitioning to state S, π(S)Q(S′|S)=n(S′)Q(S|S′). This document discusses the detailed balance condition in more detail elsewhere below.

In the MH algorithm, the transition probability Q(S′|S) is separated into a proposal distribution q(S′|S), describing the probability of proposing a move to state S′ from state S, and an acceptance probability a(S′,S), the probability to accept the proposed state S′. Therefore, Q (S′|S)=q(S′|S)·a(S′, S). The acceptance probability is further specified as

$$a ( {S}^{′} , S ) = min ( 1 , \frac{π ( {s}^{′} )}{π ( s )} \frac{q ( S \vert {S}^{′} )}{q ( {S}^{′} \vert S )} ) ,$$

so that detailed balance is ensured. The proposal distribution q(S′|S) is defined as a uniform distribution over some set of states S′. The method may utilize symmetric proposal distributions q(S′|S)=q(SIS′). Hence the acceptance probability is simplified to

$$a ( {S}^{′} , S ) = min ( 1 , \frac{π ( {S}^{′} )}{π ( S )} ) .$$

Based on the definition of π(S) in (6), the acceptance probability is 1 if the proposed state S′ has a smaller distance measure than the current state S. With the above specifications, the system can simulate transitions on the designed Markov chain until it converges to the desired probability P(S) and then draw a sample. Since the sample is drawn from the desired probability P(S), the network properties (degree and clustering coefficient in our example) of the resulting samples can optimally represent that of the population.

The discussion further includes applying MH to ego-network sampling. In the peer encouragement designs for network experiments, the unit of sample is ego network which will be assigned to different treatment conditions. When applied to such design, the proposed MH algorithm may be adapted to answer the following questions: how to adjust the algorithm to sample ego networks rather than nodes? How to incorporate the constraints specified in (4) so that there are not first- or second-degree contaminations between the sampled egos? How to ensure samples in different treatment conditions are equally optimized in the sampling procedure?

The discussion continues with sampling of ego networks. So far, the discussion has focused on sampling the egos S_{d} for treatment condition d; however, it is worth noting that by construction once an individual i in the population is sampled as an ego, all the alters A(i) are automatically included in the sample set for treatment condition d and they are no longer eligible to be sampled as an ego under peer encouragement designs. Therefore, the overall samples for treatment condition d is actually {S_{d}, A(S_{d})}, including the egos and the alters. Since the alter set A(S_{d}) is implicitly determined by the ego set S_{d}, the discussion may focus on the sampling of S_{d} and assume that the sampled alter set A(S_{d}) is automatically derived from the ego set S_{d}. In the proposed MH algorithm, the key idea is that, in each iteration, to consider a swap by removing an ego i from S_{d} and the correspondent A(i) and adding a new ego node i′ and the correspondent A(i′) to S_{d}, and then accepts the swap with the given probability.

The discussion continues with adapting the proposal distribution. For current state (sample) S, the constraints in (4) add restrictions to the eligible nodes for a new state S′. Hence, the system may need to adapt the proposal distribution q(S′ IS), so that the detailed balance still holds. To do so, the system may first remove a randomly selected ego from S and obtain a reduced sample Sᵣ with n−1 egos. Next, the system may randomly select a node i′ that satisfies the constraints as an eligible ego from a restricted candidate set C(Sᵣ)={i′∈G|i′∉Sᵣ|i′ ∉A(Sᵣ)|A(i′)∩A(Sᵣ)=∅} and add it to the reduced sample S. Then the system may decide whether to accept this new sample S′ according to the acceptance probability a(S′,S). The key idea is to define this restricted candidate set C(Sᵣ) according to the constraints. Note that the restricted candidates set C(Sᵣ) is defined by the current reduced sample Sᵣ. Therefore, C(Sᵣ) will be updated accordingly once the Markov chain moves to a new sample state. Under this construction, the proposal distribution is symmetric, and the detailed balance holds.

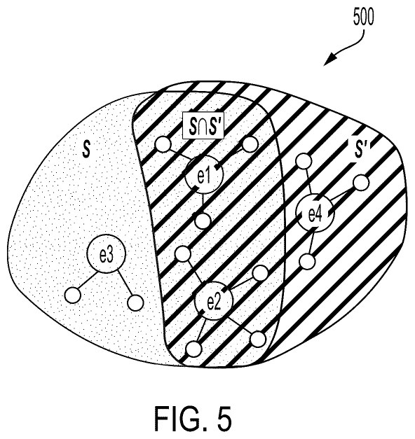

Consider the following proof of symmetry proposal distribution under constraint. While referencing FIG. 5, an illustration of symmetry proposal distribution under constraint in graph 500 is provided. Note that the proposal probabilities q(S′|S) and q(S|S′) describe the chances of constructing S′ out of S and S out of S′ respectively where S′≠S. Suppose that the system is sampling n ego networks from the population. By construction, the intersection of the two states S∩S′ contains n−1 ego networks because one may first remove a randomly drawn ego (and the ego's alters) from the current set of samples (S or S′) and obtain a reduced sample S∩S′. The probability of arriving at S∩S′ from the current state S or S′ is 1/n. Then, the probability of transitioning from S∩S′ to the next state S′ or S is

$$\frac{1}{{n}_{C ( S ∩ {S}^{′} )}} where {n}_{C ( {S∩S}^{′} )}$$

is the number of nodes in the restricted candidate set which satisfies any node in this restricted candidate set is at least 3 hops apart from S∩S′. Hence, one can illustrate the proposal probabilities as:

$$P ( S \to S ∩ {S}^{′} ) = \frac{1}{n} ,$$

$$and$$

$$P ( S∩ {S}^{′} \to {S}^{′} ) = \frac{1}{{n}_{C ( {S∩S}^{′} )}} ,$$

$$so$$

$$q ( {S}^{′} \vert S ) = \frac{1}{n} \cdot \frac{1}{{n}_{C ( {S∩S}^{′} )}} ,$$

### Similarly,

$$P ( {S}^{′} \to {S}^{′} ∩ S ) = \frac{1}{n} ,$$

$$and$$

$$P ( {S}^{′} ∩ S \to S ) = \frac{1}{{n}_{C ( {S}^{′} ∩S )}} ,$$

$$so$$

$$q ( S \vert {S}^{′} ) = \frac{1}{n} \cdot \frac{1}{{n}_{C ( {S}^{′} ∩S )}} .$$

Therefore, q(S′|S)=q(S|S′). For S′=S this is trivial. An illustration of this principle is provided in FIG. 5 in a graph 500 where n=3.

The discussion may continue with an exploration of treatment conditions. Suppose an experiment involves two treatment conditions d∈{T,C} and a sample of n ego networks per condition, S_{T} and S_{C}, is desired. One possible way to incorporate treatment conditions in the sampling procedure is to first obtain a representative sample of 2n ego networks and then randomly assign them to the two conditions with equal probability; however, this could result in sample imbalance in terms of degree distribution between conditions because degree distribution is highly skewed. For instance, one condition could contain more high-degree egos than the other condition. To ensure that samples are balanced between conditions and both groups represent the population, the system may first randomly assign an initial set of samples to the two conditions with equal probability (e.g., S_{T} and S_{C}, each with n ego networks) and then apply the MH algorithm to update one group in each iteration.

This may be done in three steps: first, selecting the samples from one condition (e.g., S_{T}) to be updated; then, proposing a new sample state S_{T}′ by removing a randomly picked ego i in S_{T} and adding a new ego i′ from the (updated) restricted candidate set C(S_{D}_{ᵣ},)={i′∈G|i′∉S_{D}_{ᵣ}|i′∉A(S_{D}_{ᵣ})|A(i′)∩A(S_{D}_{ᵣ})=∅} where S_{D}_{ᵣ}={S_{T}∪S_{C}\i} is the reduced set of all current egos for both treatment conditions except ego i. Lastly, accepting the proposed sample state S_{T}′ with acceptance probability a(S_{T}′, S_{T}).

One challenge is that the sampling procedure is not efficient if the group of samples to be updated is randomly picked in each iteration because good samples are much rarer than worse ones. By chance, it could lead to samples in one condition with a higher quality and samples in the other with a lower quality. To ensure equal sample quality across treatment conditions and improve the sampling efficiency, one may generate an indicator in each iteration from a Bernoulli random variable g˜Ber(p), with

$$p = \frac{Δ ( {f}_{1 , 2} ( {S}_{T} ) , {f}_{1 , 2} ( G ) )}{{\sum }_{d} Δ ( {f}_{1 , 2} ( {S}_{d} ) , {f}_{1 , 2} ( G ) )} , d ∈ \{ T , C \} ,$$

to determine whether sample S_{T} (if g=1) or sample S_{C} (if g=0) is selected to be updated. It implies that the group of samples with a larger distance from the population (e.g., lower quality) in the current iteration will have a higher chance to be updated. Therefore, as MCMC converges, the treatment and control conditions will exhibit equal sample quality.

The proposed MH ego-network sampling algorithm can thus be summarized as follows:
1. Initialize
   (1) Pick 2n ego networks from G subject to the constraints as Sᵢₙᵢₜᵢₐₗ.
   (2) Randomly pick n ego networks from Sᵢₙᵢₜᵢₐₗ for treatment condition T and the rest n ego networks for condition C.
   (3) Set sample states as {S_{C}^{t},S_{T}^{t}}, the restricted candidate set as C(S_{d}_{ᵣ}^{t}), the set of best samples as {S_{C}^{best}, S_{T}^{best}} and t=0.
2. Iterate
   (1) Select sample S_{d}^{t} for treatment condition d=T (if g=1) or d=C (if g=0) to be updated according to the Bernoulli random number g˜Ber(p).
   (2) Generate a new state S_{d}′ by swapping an ego in the current state S_{d}^{t} and a node in the restricted candidate set C(S_{d}_{ᵣ}^{t}) according to the proposal distribution q(S_{d}′|S_{d}^{t}).
   (3) Calculate the acceptance probability a(S_{d}′, S_{d}^{t}).
   (4) Accept or reject.
      a. Generate a uniform random number α∈[0,1].
      b. If α≤a(S_{d}′, S_{d}^{t}), then accept the new state.
         i. Update the sample state S_{d}^{t+1}=S_{d}′ and update the restricted candidate set C(S_{d}_{ᵣ}^{t+1}).
         ii. If Δ(f_{1,2}(S_{d}′), f_{1,2}(G))<Δ(f_{1,2}(S_{d}^{best}), f_{1,2}(G)), then update the best sample S_{d}^{best}=S_{d}′.
      c. If α>a(S_{d}′, S_{d}^{t}), then reject the new state and set S_{d}^{t+1}=S_{d}^{t}.
   (5) Increment: set t=t+1.

The sampling procedure repeats for T iterations and stops when the chain reaches convergence with minimal gain in the distance measure. Over the T iterations, the joint distribution of variables considered in the sampling algorithm is computed for every candidate sample visited by the Markov chain. The two network properties considered (e.g., degree and clustering coefficient) are easy to obtain in practice and computationally efficient. With these benefits, the method is computationally efficient as the average CPU runtime of the algorithm with 200,000 iterations is 1,282 seconds on a PC (128 GB RAM and i9 3.6 GHz 18 cores) in the settings investigated the simulation study.

The discussion now turns to the superior quality of the representative samples. The discussion continues with an evaluation and comparison of the quality of samples drawn from the disclosed method (“representative samples”) with the samples obtained from the benchmark excluding approach (“baseline samples”) on sample sizes, sample representativity, and the influence on other individual covariates.

The discussion may continue by simulating a population network. The power-law degree distribution has been observed in a wide range of networks. However, most social networks that exhibit power-law behavior also have relatively high clustering. The system may generate a power-law cluster network. For illustration, the system may simulate a population network of size N=100,000, with an average degree of 4 and clustering coefficient of 0.075. The value of clustering coefficient value is chosen to reflect what has been observed in the real world online social networks.

In real-world settings, many variables other than network properties are also of great importance in experiments. One may also generate two variables to represent different types of individual information: (1) a binary variable z₁∈{0,1} that is independent of individual network properties. It could be interpreted as individual's demographic information, such as gender; (2) a continuous variable z₂ which positively correlates with degree with a correlation coefficient of 0.5. It could be interpreted as individual behavior on social networks that is highly correlated with one's degree, such as the number of posting or the volume of browsing.

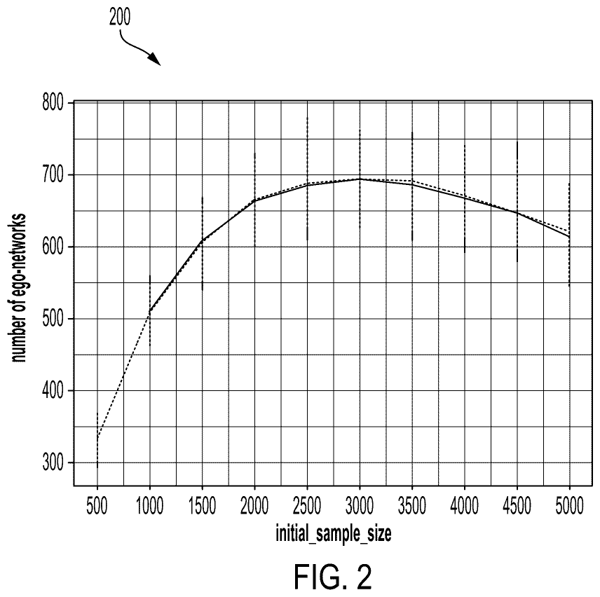

For a fair comparison of the method with the benchmark excluding approach, it is important to choose a proper sample size (e.g., the number of ego networks) for the task. For the excluding approach, the system may first consider the remaining number of ego networks under various initial sample size conditions ranging from 500 to 5,000 ego networks with the step-size of 500 per treatment condition. For each initial sample, the system may exclude any ego networks if two egos are directly connected or share at least one common alter (the constraints in (4) discussed herein). FIG. 2 is a chart 200 that plots the number of remaining ego networks in each treatment condition under various initial sample sizes for the excluding method. The maximum number of remaining ego network samples turns out to be about 700 when the number of initial ego networks is 3,000 per condition. Based on this observation, the system may set the initial sample size as 3,000 ego networks per condition for the excluding approach and set the number of ego network samples as 700 per condition for this approach to match with the remaining sample size in the excluding approach. The system may then repeat the sampling procedure 500 times for each sampling method to obtain the simulated samples.

The discussion continues with reference to FIG. 2 for an elaboration on sample size. As shown in FIG. 2, the chart 200 shows that excluding contaminated ego networks reduces sample size by at least 50%. Moreover, increasing the initial random sample size does not necessarily result in a larger qualified sample. In fact, the relationship between the initial and resulting sample sizes is inverted-U, which means there exists a cap for the maximum number of remaining samples for the excluding approach. This is because the more ego networks are picked as initial samples, the more links exist between them hence more ego networks are eventually excluded. This observation draws attention to the potential treatment contaminations in network experiments with increasing scale and scope. On the other hand, the proposed sampling method takes sample size as an input parameter in the algorithm and can obtain up to 3,000 representative ego-network samples per condition with better sample quality (measured by KS distance) than the baseline samples. In many field experiments, the effects of marketing interventions on the targeted individuals and the social influence exerted by them could be minimal due to the exploratory purpose of these experiments or concerns on potential risks. Thus, these experiments require large sample size to estimate the direct and indirect treatment effects precisely. From this perspective, the proposed method enjoys more experimental efficiency.

The discussion continues with the topic of sample representativity. The system compare the sampled egos from the two sampling methods with individuals in the population network on two network properties—degree and clustering coefficient, as well as on two personal characteristics. For each network property, the system uses the KS distance defined in (5) to evaluate the difference of its distributions in a set of sampled egos and in the population network, with smaller values indicating higher similarity.

Summary of Samples from Representative Sampling and Excluding Methods

TABLE 1

| | Population | Representative method | | Excluding method | |
|---|---|---|---|---|---|
| | value | treatment | control | treatment | control |
| number of nodes | | 700 | 700 | 692.68 | 691.55 |
| Avg. degree | 4.00 | 3.755 | 3.758 | 2.567 | 2.566 |
| KS distance | | (0.005) | (0.005) | (0.180) | (0.181) |
| Avg. clustering coefficient | 0.075 | 0.077 | 0.077 | 0.093 | 0.093 |
| KS distance | | (0.005) | (0.005) | (0.063) | (0.063) |
| Avg. Z₁ (binary) | {0, 1} | 0.500 | 0.500 | 0.501 | 0.500 |
| % chi-square test rej. H0: | | 5.2% | 5.2% | 4.8% | 5.6% |
| sample = population | | | | | |
| Avg. Z₂ (continuous) | 1.61 | 1.503 | 1.503 | 1.024 | 1.020 |
| % T-test rej. H0: sample = | | 1.4% | 1.6% | 59% | 64% |
| population | | | | | |

In Table 1, each row represents the mean value of a network or individual variable over 500 simulations. The average KS distance of the variable is in paratheses. Table 1 describes the average of these network properties for egos in the representative samples and in the baseline samples and shows the average KS distances in parentheses. First, the system examines the degree distribution. While the average degree in the population network is 4, the average degrees of egos in the representative samples and in the baseline samples are 3.76 and 2.57, respectively, suggesting that the excluding approach results in a large proportion of low-degree egos in the sample. The average KS distance is also much larger in baseline samples than in representative samples (0.18 and 0.005, respectively). Similarly, the system finds that the average clustering coefficient of egos in the baseline samples (0.093) is further away from what is observed in the population (0.075) than that in representative samples (0.077). This comparison shows face validity of the method in that it can better maintain the representativity of degree distribution and clustering coefficient distribution in the samples.

The discussion continues with the topic of other covariates. The discussion also demonstrates that the proposed method will not affect the distributions of other covariates not used in the sampling procedure. The system does so by comparing the sample means of the two constructed personal covariates z₁ and z₂ and their population means. The last two rows of Table 1 summarize the results. By construction, z₁ is a binary variable independent of any network properties. One may conduct a Chi-square test to determine whether the distribution of z₁ in the sampled egos is the same as in the population. Over 500 simulations, the percentage of Chi-square test rejecting the null hypothesis (sample proportion=population proportion of z₁=1) is about 5% under both sampling methods. On the other hand, z₂ is a continuous variable positively correlated with individual degree. The mean value of z₂ in the baseline samples is much less than the population mean (1.02 and 1.61 respectively). Meanwhile, over the 500 simulations, the rate is around 60% of t-test rejecting the null hypothesis that the mean of z₂ in the samples is the same as in the population. In contrast, the mean value of z₂ in the representative samples is much closer to the population mean (1.50 and 1.61 respectively), and the rate of t-test rejecting the null hypothesis (sample mean=population mean) is only around 1.5% over 500 simulations. In sum, when a covariate is independent of network properties used in the sampling procedure (e.g., degree and clustering coefficient), the proposed method does not affect its distribution in the resulting samples; when a covariate is correlated with these network properties, the method ensures that the distribution of the covariate remains to be representative of the population.

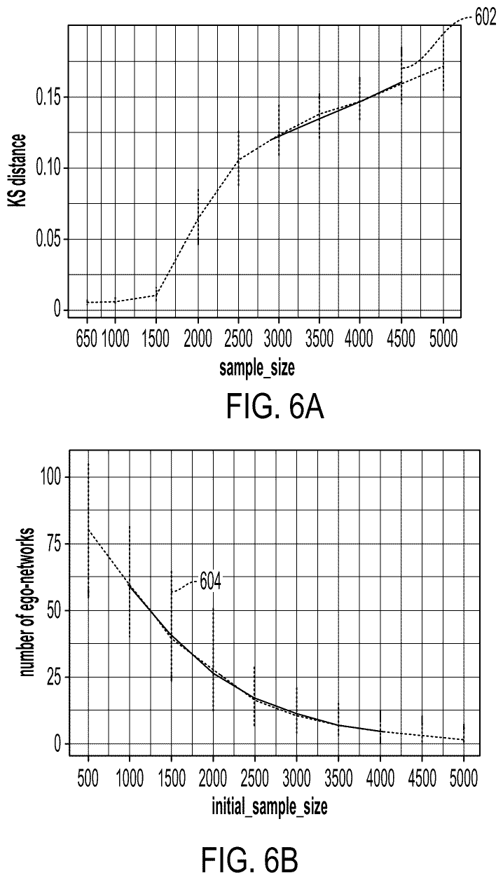

The discussion continues with the topic of performance in other scenarios. Sampling non-overlapped ego networks can be more difficult if the desired sample size is large, or the network is dense. One may evaluate how the method performs compared with the excluding approach under these conditions and briefly discuss the results. For instance, referring to FIGS. 6A and 6B, various aspects are shown. FIG. 6A illustrates KS distance with increasing sample sizes. The vertical bars 602 show the maximum and minimum KS distances under each sample size across 100 simulations. FIG. 6B illustrates sample size after excluding contaminated nodes in a dense network. The vertical bars 604 show the maximum and minimum numbers of remaining ego network sample sunder each initial sample size across 100 simulations.

As mentioned, one may evaluate how the method performs compared with the excluding approach under these conditions and briefly discuss the results. First, one may increase the sample size (e.g., the number of ego networks) in each treatment condition and find that the method can efficiently sample 5,000 ego networks per condition without significant loss on sample quality. Second, one may increase the density of the power-law cluster network (avg. degree=10 and avg. clustering coefficient=0.135) and find that the method is able to sample up to 1,500 ego networks per condition, whereas the excluding method can only obtain less than 100 ego networks per condition. In sum, these results demonstrate that the method can be useful in obtaining high-quality ego-network samples when the required sample size is large, or the population network is dense.

The discussion continues with the topic of improved causal inference with the representative samples. Simulations are conducted to compare the proposed representative treatment and control samples with the baseline samples from the benchmark excluding method in estimating the direct and indirect treatment effects. To facilitate comparison, first specify the response models for the targeted egos and their alters with heterogeneous direct and indirect treatment effects and simulate responses of the sampled individuals according to the models. Then estimate the average treatment effects and the heterogeneity parameters with the representative samples and the baseline samples respectively using the same estimation method and compare the precision and power of the treatment effect estimates.

The discussion continues with reference to response models. An individual's potential outcome Yᵢ depends on his/her own treatment status dᵢ, the immediate neighbors' treatment status d₋ᵢ, and the individual's characteristics xᵢ. Consider individual i who is an ego and individual j(i) who is an alter of ego i. Since the intervention is only randomized on egos and none of the alters is treated, ego i does not receive any indirect treatment from the peers; on the other hand, alter j(i) does not receive the treatment but could experience indirect treatment from the connected ego i. One may specify the response models of ego i and alter j(i) as:

$${y}_{i} = α + β {x}_{i} + {τ}_{i} {d}_{i} + {ξ}_{i} + {ε}_{i} , \qquad ( 7 )$$

$${y}_{j ( i )} = α + β {x}_{j ( i )} + {γ}_{j ( i )} {d}_{i} + {ξ}_{i} + {ε}_{j ( i )} ,$$

where τᵢ measures the direct treatment effect of ego i and γⱼ₍ᵢ₎ measures the indirect treatment effect of alter j(i).

Within an ego network, the outcomes yᵢ and γⱼ₍ᵢ₎ are likely to be correlated because of similarity (e.g., homophily) or unobserved common shocks. For this reason, add an ego-network specific component ξᵢ to the outcomes of individuals in the same ego network, and assume ξᵢ˜N(0, σ_{ξ}). Lastly, εᵢ and εⱼ₍ᵢ₎ are random errors and follow the distribution ε˜N(0, σ_{ε}).

Consider three individual personal characteristics in xᵢ′=[kᵢ, z₁ᵢ, z₂ᵢ], including degree kᵢ and the two constructed personal characteristics z₁ᵢ and z₂ᵢ. Log-transform the individual degree and set the values of the coefficients of individual characteristics xᵢ′ as β=[0.5, −0.5, 0.2] and the intercept as α=1.

Assume that the targeted egos respond heterogeneously to the marketing intervention. As discussed early, individuals' response to the targeting intervention on social networks can depend on their network positions, as well as personal characteristics. Therefore, assume that the treatment effect of ego i is determined by the degree kᵢ and personal characteristics z₁ᵢ and z₂ᵢ. Also add the squared term of degree kᵢ² to capture non-linear effect from the degree (e.g., a diminishing or enhancing effect). The individual treatment effect is specified as

$${τ}_{i} = {τ}_{0} + {τ}_{1} {k}_{i} + {τ}_{2} {k}_{i}^{2} + {τ}_{3} {z}_{1 i} + {τ}_{4} {z}_{2 i} , \qquad ( 8 )$$

with the coefficients τ′=[τ₀, τ₁, τ₂, τ₃, τ₄]=[1, 1, −0.0001, −0.5, 0.2].

Assume that each ego exerts different social influence on the neighbors, which is proportional to the ego's own treatment effect; therefore, specify γⱼ₍ᵢ₎=θτᵢ where θ is a spillover parameter and set the value of θ as 0.5.

Quantifying the average direct and indirect treatment effects. First focus on the ADTE (the average direct treatment effect τ=τ̅ᵢ) of the targeted intervention, which is of interest when considering whether an intervention can significantly change the behavior of the targeted individuals and how much of changes would be observed on average. The ADTE describes the average effect of the treatment on an individual whose direct neighbors are not treated, and is estimated by the mean-difference of the sampled egos in the treatment condition S_{T} and in the control condition S_{C},

$$\hat{τ} = \frac{1}{{n}_{T}} {\sum }_{i ∈ {S}_{T}} {Y}_{i} - \frac{1}{{n}_{C}} {\sum }_{i ∈ {S}_{C}} {Y}_{i} . \qquad ( 9 )$$

Next, the AITE (the average indirect treatment effect γ=γ̅ⱼ₍ᵢ₎) describes the average effect of the treatment spills over from egos to their connected alters. First take the average of alter outcomes at ego-network level and use the mean-difference of this ego-network level quantity across treatment conditions to estimate the AITE,

$$\hat{γ} = \frac{1}{{n}_{T}} {\sum }_{i ∈ {S}_{T}} {\overline{Y}}_{j ( i )} - \frac{1}{{n}_{C}} {\sum }_{i ∈ {S}_{C}} {\overline{Y}}_{j ( i )} , \qquad ( 10 )$$

$$where$$

$${\overline{Y}}_{j ( i )} = \frac{1}{{k}_{i}} {\sum }_{j ∈ A ( i )} {Y}_{j}$$

is the average outcome of all alters j connecting to ego i and kᵢ is the degree of ego i.

Compare the ADTE and AITE estimates based on representative samples versus the baseline samples generated from the excluding approach. The evaluation metrics include the bias (e.g., the difference between the estimate and the true value) and root mean squared error (RMSE), as well as the statistical power and coverage of the estimated ADTE and AITE across the 500 simulations (Table 2). Table 2 shows average direct and indirect treatment effect estimates. In Table 2, the mean estimated ADTE and AITE are averaged over the 500 simulations for each sampling method. The test power is the average rate of rejecting the null hypothesis across the 500 simulations, and the coverage is the average rate of the estimated confidence interval covers the true effect.

TABLE 2

| | |
|---|---|
| Representative | Excluding |
| method | method |

Average Direct Treatment Effect \hat{τ} (true = 4.995)

| | | |
|---|---|---|
| mean \hat{τ} | 4.775 | 3.512 |
| bias \hat{τ} − τ̅ | −0.220 | −1.483 |
| RMSE \hat{τ} | 0.251 | 1.487 |
| test power | 100% | 100% |
| coverage | 92% | 0% |

Average Indirect Treatment Effect \hat{γ} (true = 2.498)

| | | |
|---|---|---|
| mean \hat{γ} | 2.392 | 1.758 |
| bias \hat{γ} − γ̅ | −0.106 | −0.739 |
| RMSE \hat{γ} | 0.185 | 0.744 |
| test power | 100% | 100% |
| coverage | 94% | 0% |

As expected, inference based on representative samples leads to smaller biases of the estimated ADTE and AITE, as compared with the baseline samples. More specifically, the system is able to reduce the average bias of the estimated ADTE from −1.483 to −0.220 and the average bias of the estimated AITE from −0.739 to −0.106, an 85% reduction in both cases. The system computes the true ADTE and AITE as follows. For individual i E N in the population, calculate the individual direct treatment effect Yᵢ(1, 0, xᵢ)−Yᵢ(0, 0, xᵢ), and take the average of the N vector of such difference to obtain ADTE. By construction, the AITE equals θ×ADTE in the simulation. Under the response model, the true ADTE and AITE are 4.995 and 2.498, respectively.

Moreover, one can obtain more stable estimates using representative samples because the RMSEs of the estimated ADTE and AITE are much smaller than the RMSEs obtained using the baseline samples, which increases the reliability of conclusions drawn from one trial.

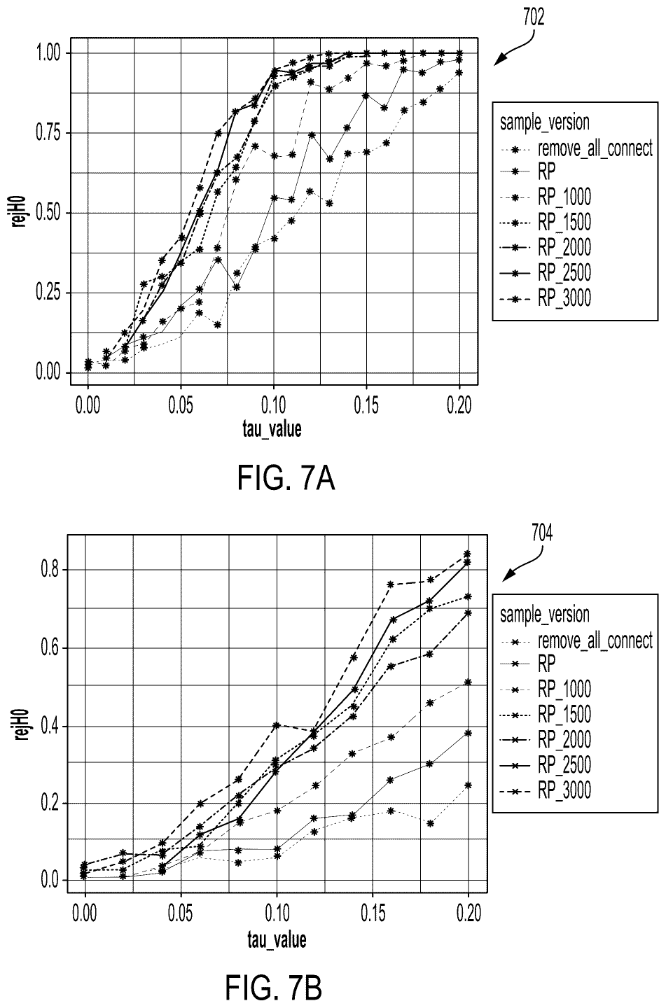

Next, compare the statistical power of the estimates, which is measured as the average rate of the estimated effects being significantly different from zero (e.g., rejecting the null hypotheses of no effect) while the true effect is not zero, between representative samples and baseline samples (Table 2). Using samples from both methods, one can successfully conclude a significant ADTE and AITE in the 500 simulations. This is not surprising because the magnitude of treatment effects is large in the simulation (e.g., the true ADTE is 4.995). However, when the treatment effect is small and correlated with individual degree, one can increase the statistical power for causal inference using the sampling method because it provides more representative samples and larger sample size for inferences. With reference to FIGS. 7A and 7B, illustration(s) of this pattern are shown. These figures illustrate a statistical power of testing the average treatment effects. For instance, FIG. 7A shows a power of average direct treatment effects (egos) 702. FIG. B shows a power of average indirect treatment effects (alters) 704.

FIGS. 7A-7B show that the method can provide higher statistical power when the treatment effects are minimal because it allows researchers to obtain larger sample sizes. To do so, one increases the number of ego network samples in each treatment condition from 1,000 to 3,000 by a step of 500 in addition to the 700 samples used in the simulation. For the excluding approach, keep the 700 ego network samples as discussed in the simulation. For each of these sample sizes, repeat the sampling procedure 100 times.

To make the comparison surrounding the detection of the minimal treatment effect, simplify the response model such that one may only keep degree in the individual treatment effect specification τᵢ=τ*log(kᵢ) and vary the value of τ from 0.0 to 0.2 by a step of 0.02. The indirect treatment effect is still θτᵢ for alters connecting to ego i with θ=0.5. Meanwhile, turn off the covariate effect and ego-level random effect and set β=0, ξᵢ=0, and εᵢ˜N(0,1).

FIGS. 7A-7B plot the statistical power for testing the ADTE and AITE respectively when sample size increases. The y-axis shows the statistical power, which is measured as the proportion of the 100 tests that rejects the null hypothesis. As expected, the samples have higher statistical power than samples from the excluding approach when the sample sizes are the same (700 ego networks per condition). Moreover, the method could increase the power of testing minimal treatment effect by providing a larger size of qualified samples.

Lastly, examine the coverage, which is measured as the probability that the estimated confidence interval covers the true value. While the coverages of the estimated ADTE and AITE using representative samples are 95% and 93% respectively, the coverages of the estimated ADTE and AITE using the baseline samples are both 0%. This result again suggests that the excluding approach results in nonrepresentative samples of low-degree individuals which lead to underestimation of the treatment effects.

In sum, the proposed sampling method generates more representative samples which help produce more accurate average treatment effect estimates and higher statistical power, improving the quality of marketing decision making. To identify the subpopulation who are more sensitive to the treatment and/or more influential to their friends in targeted campaigns, companies are also interested in inferences surrounding the heterogeneity of treatment responses. Next, the discussion illustrates how representative samples can help more accurately quantify the heterogeneous treatment effects.

Quantifying the heterogeneous treatment effects: The heterogeneous treatment effects (HTE) can be used to understand and predict how different subpopulations would respond to the targeting intervention. Leveraging the “true” data-generating process in the simulation, one may evaluate samples obtained from the two sampling approaches in estimating the heterogeneity parameters and predicting the treatment effects using a Bayesian parametric inference procedure and a nonparametric procedure.

Bayesian inference of parameters in the HTE: begin the analysis by estimating the parameters in the response models, particularly focusing on the parameters that determine the individual treatment effect τᵢ in (8). Because individual outcomes in the same ego network are correlated through the ego-network level random effect ξᵢ, estimate the model parameters using a random-effect Bayesian approach.

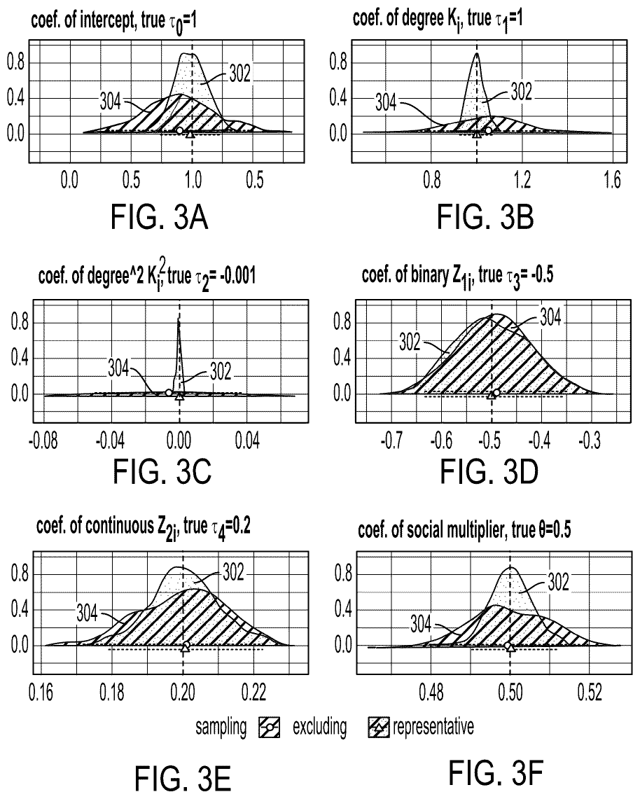

FIGS. 3A-3F plot the posterior distributions of the individual treatment effect parameters τ₀, τ₂, τ₃, τ₄ and the spillover parameter θ estimated using the representative samples 302 and the baseline samples 304. For each parameter, the horizontal lines show the 95% quantile intervals of the posterior means, and the dotted line shows the true value. Table 3 below shows the posterior distribution of all model parameters. In the table the 95% CPI is the 95% posterior confidence interval.

TABLE 3

| | True | Representative Sampling | | Excluding Approach | |
|---|---|---|---|---|---|
| | value | posterior mean | 95% CPI | posterior mean | 95% CPI |
| α | 1 | 1.000 | (0.909, 1.088) | 1.006 | (0.901, 1.114) |
| β₁ | 0.5 | 0.500 | (0.474, 0.531) | 0.499 | (0.452, 0.547) |
| β₂ | −0.5 | −0.496 | (−0.552, −0.443) | −0.496 | (−0.566, −0.438) |
| β₃ | 0.2 | 0.200 | (0.198, 0.202) | 0.200 | (0.195, 0.205) |
| τ₀ | 1 | 0.991 | (0.737, 1.242) | 0.910 | (0.3, 1.522) |
| τ₁ | 1 | 0.999 | (0.934, 1.075) | 1.050 | (0.707, 1.402) |
| τ₂ | −0.001 | −0.001 | (−0.004, 0.001) | −0.006 | (−0.05, 0.038) |
| τ₃ | −0.5 | −0.497 | (−0.634, −0.352) | −0.494 | (−0.642, −0.348) |
| τ₄ | 0.2 | 0.201 | (0.179, 0.222) | 0.200 | (0.171, 0.223) |
| θ | 0.5 | 0.500 | (0.49, 0.511) | 0.500 | (0.479, 0.519) |
| σ_{ξ} | 1 | 1.007 | (0.958, 1.053) | 1.002 | (0.955, 1.053) |
| σ_{ε} | 1 | 1.001 | (0.982, 1.02) | 1.001 | (0.978, 1.026) |

One may find that the estimates of individual treatment effect parameters using representative samples are more accurate and reliable compared with the estimates obtained using baseline samples because the posterior means are more concentrated around the true values. In particular, the representative samples are superior to random samples in estimating the coefficient of individual degree (ii) and capturing the nonlinear effect of individual degree (e.g., τ₂). With representative samples, the system can largely reduce the 95% quantile intervals of τ₁ and τ₂ from the baseline samples. Meanwhile, the estimates of personal characteristic parameters (e.g., τ₃ and τ₄ for variables z₁ and z₂) using representative samples are slightly better than those using the baseline samples even though the two variables are not considered in our sampling procedure. Finally, the posterior estimate of the spillover parameter (θ) also suggests that using representative samples can increase the accuracy of the indirect treatment effect estimation.

The discussion continues with reference to prediction of heterogeneous treatment responses. To further evaluate the two sampling methods, conduct out-of-sample posterior prediction of the treatment effects on individuals in the population. The idea is to investigate how accurately the system can predict different subpopulations' responses to the treatment based on the parameter estimates obtained from representative samples and baseline samples. Since in the simulation, it is assumed that individual treatment effect varies with degree kᵢ and personal characteristics z₁ᵢ and z₂ᵢ, the effort focuses on the subpopulations based on these dimensions.

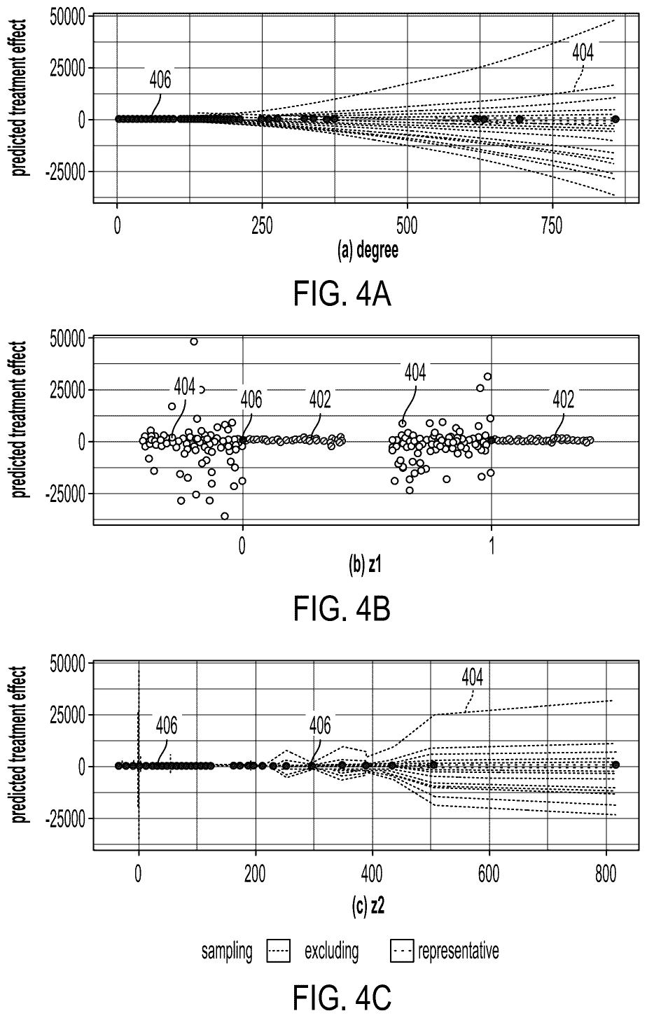

For illustration purpose, 20 groups of treatment/control samples are randomly selected for each sampling method, the response model parameters are estimated using these samples, and the out-of-sample prediction of individual treatment effects is obtain based on the parameter estimates. FIGS. 4A-4C plot the predicted individual treatment effects for individuals in the population based on estimates from representative samples 402 (color blue) and from baseline samples 404 by (a) individual degree, (b) groups of z₁ and (c) values of z₂. The darker dots 406 in each figure indicate the true individual treatment effects. Across all conditions, one consistently finds that using the representative samples and the corresponding parameter estimates, the system is able to obtain much more accurate predicted treatment effects for various subpopulations. On the other hand, the predicted treatment effects based on estimates using the baseline samples exhibit a large variability.

One may wonder that in real-world settings, one may not know the true data-generating process and hence may face model misspecification in estimating the parameters. Note that the purpose of recovering the true parameters and predicting the treatment effects of individuals in the population is to evaluate the two sampling methods rather than suggesting a way to analyzing HTE. Next, the discussion utilizes a nonparametric approach that is often applied in experimental data for analyzing HTE to further compare the two sampling methods.

The discussion continues with reference to the conditional average treatment effect. The discussion compares the two sampling methods by analyzing the conditional average treatment effect (CATE), which measures the treatment effect as it varies with covariate x, τ(x)=E[Yᵢ(1,0, xᵢ)−Yᵢ(0,0,xᵢ)|xᵢ=x]. The main idea is to estimate the average treatment effect for subpopulations conditional on the x values in the sample and use the estimated CATE to predict how different subpopulations would respond to the treatment. In this sense, the CATE is a nonparametric estimation because it does not assume specific models of how individual characteristics determine individual treatment effects.

For illustration, choose degree kᵢ as the conditional variable. As degree is a continuous variable, first split degree into six groups: 2-4, 5-10, 11-15, 16-20, 21-25, and >26. Conditional on samples in each degree group, then estimate the CATE for this subpopulation using the “ego-mean-difference” estimator in (9). Repeat this procedure for all the 500 simulations and for each sampling method.

TABLE 4

| Degree | Population | Representative method | | Excluding method | |
|---|---|---|---|---|---|
| group | CATE | mean | std | mean | std |
| 2-4 | 3.443 | 3.437 | 0.111 | 3.290 | 0.110 |
| 5-10 | 7.669 | 7.691 | 0.306 | 6.996 | 0.599 |
| 11-15 | 14.180 | 14.143 | 1.068 | 13.437 | 4.259 |
| 16-20 | 19.446 | 19.382 | 2.235 | N/A | N/A |
| 21-25 | 24.793 | 24.742 | 3.994 | N/A | N/A |
| >25 | 52.071 | 36.113 | 7.775 | N/A | N/A |

Table 4 reports the estimated CATE by degree groups and by sampling methods. A cell with N/A means that there is no available sample in that degree group. Column 2 shows the CATEs at population level. Columns 3 and 4 are the mean and standard deviation of the estimated CATEs using the representative samples. Columns 5 and 6 report the mean and standard deviation of the estimated CATEs using the baseline samples. Several findings can be concluded. First, the estimated CATEs using the representative samples are very close to the population values for almost all degree groups except the extremely high-degree one. Second, the estimated CATEs using the representative samples are more reliable because the standard deviations across 500 simulations are much smaller than the estimated CATEs using the baseline samples. Moreover, what is concerning is that some high-degree subpopulations (e.g., degree groups 16-20, 21-25, and >25) are entirely missing in the baseline samples, making the out-of-sample predictions in those cases difficult.

In sum, as a nonparametric approach, CATE infers HTE conditional on the values of covariates observed in the data. This can be challenging for the baseline samples from the excluding approach because the available samples in some subpopulations can be limited or even entirely missing. In such case, the CATE needs to predict the treatment effects for those subpopulations based on most similar individuals in the sample, which could result in inaccurate conclusions.

Despite the wide use of peer encouragement designs in network experiments for evaluating targeted campaigns on social networks, it is difficult to obtain representative and qualified samples to facilitate estimation of the direct treatment effects on the focal individuals as well as the indirect treatment effects on those connected to the focal ones. The common practice is to draw random samples and then exclude those contaminated ones from the causal inference; however, samples constructed in this way are prone to issues of underrepresentation and undersupply.

This disclosure proposes a Bayesian representative ego-network sampling method to draw representative and qualified samples. The obtained samples enable researchers to draw more accurate inferences of the average treatment effects as well as the underlying heterogeneity in treatment responses. The proposed representative sampling method obtains samples that represent the population based on the distribution of individuals' network properties (e.g., degree and clustering coefficient). The disclosure adopts the Metropolis-Hastings algorithm to ensure that the joint distribution of the individual-level variables of the sampled units converges to the joint distribution of these variables in the population. To minimize treatment contaminations, the method embeds into the algorithm constraints on the sampled ego networks (rather than simply excluding nodes). Through simulations, the discussion demonstrates that the sampling method outperforms the conventional excluding approach in producing sizable and clean samples that highly represent the population.

Using a simulated targeting scenario in which egos respond to the treatment and hence influence their connections heterogeneously, it is shown that that the representative samples allow one to obtain more accurate and precise estimates of the average direct and indirect treatment effects compared with the baseline samples. The discussion further compares the heterogeneous treatment effects estimated from the obtained representative samples and baseline samples, respectively. Leveraging the simulation setup, a Bayesian method is used to estimate the true parameters in the response generating models for egos and alters. The disclosure finds that representative samples can facilitate more accurate estimation of the heterogeneity parameters and more accurate out-of-sample prediction of the treatment effects. Furthermore, the disclosure uses a nonparametric approach to estimate the conditional average treatment effects for subpopulations based on individual degree and find that the representative samples not only enable more accurate estimation of the CATE but also allow inferences of the treatment effects for a wider range of subpopulations (e.g., high-degree group).

The method provides an effective and efficient way to obtain high-quality ego-network samples and therefore improve the causal inference in peer encouragement designs. Accurate inference of the direct and indirect treatment effects is crucial as the success of a targeted campaign contingents upon selection of the right set of targeted individuals. Furthermore, the method allows companies to obtain more accurate estimates of causal effects with smaller but more representative samples. This is especially beneficial in situations with small treatment effect and/or involving costly experimental treatment (e.g., monetary incentives like discount).

The research can be extended in several ways, offering opportunities for follow up studies. First, the analyses are conducted on a simulated power-law cluster network, the type of networks that are widely observed in the real world, and the efficacy of the method in this network are tested under various scenarios such as when sample size increases, or population network becomes dense. Future research can further validate the performance of the proposed method in other networks.

Second, the discussion considers ego heterogeneity in terms of their responses to the treatment and the social influence they exert on their connections in this study as an illustration. Interested researchers may want to explore the heterogeneity in alters to examine how indirect treatment effects or social influences vary across subpopulations of alters. To do so, the system can adapt the sampling method to a two-step approach such that it first samples representative ego networks as before and then resample a representative subset of alters from the current alter set using an adapted Metropolis-Hastings algorithm following a few predefined conditions.

Third, the method can be adapted to other network experiments aiming at exploring what individual characteristics moderate a social influence mechanism. For example, mechanism design network experiments usually randomize the channels of social influence between egos and alters and measure the effects of different communication channels for social influences. Imagining that an alter connects to two egos (with the mechanism enabled and disabled, respectively), it becomes hard to attribute the behavioral change of the alter solely to one mechanism. The method can be easily adapted in this case by adjusting the constraint condition and objective function to ensure that (1) each alter only connects to one ego in the experiment, and (2) alters in each treatment condition are representative of population in characteristics that researchers hope to further explore.

The preceding detailed discussion introduced various systems, methods, and embodiments. However, a summary is helpful in view of the lengthy preceding treatment of the subject-matter of this application.

To reiterate, a challenge exists in current networks. Marketing interventions on social networks have become increasingly prevalent. Network experiments with peer encouragement designs have been widely used to causally quantify the heterogeneous direct and indirect effects of these interventions on focal individuals (egos) and their connected counterparts (alters). However, obtaining clean ego-network samples for treatment effects estimation is challenging because of the underlying social connections between individuals. Conventional approaches dealing with the contamination individuals from random sampling, either subsequent exclusion or post-correction, encounter two significant challenges: underrepresentation and undersupply. Underrepresentation stems from the failure to accurately represent population characteristics, leading to biased inferences and limited generalizability. Undersupply, on the other hand, results in inadequate sample sizes, diminishing statistical power and experimental efficiency.

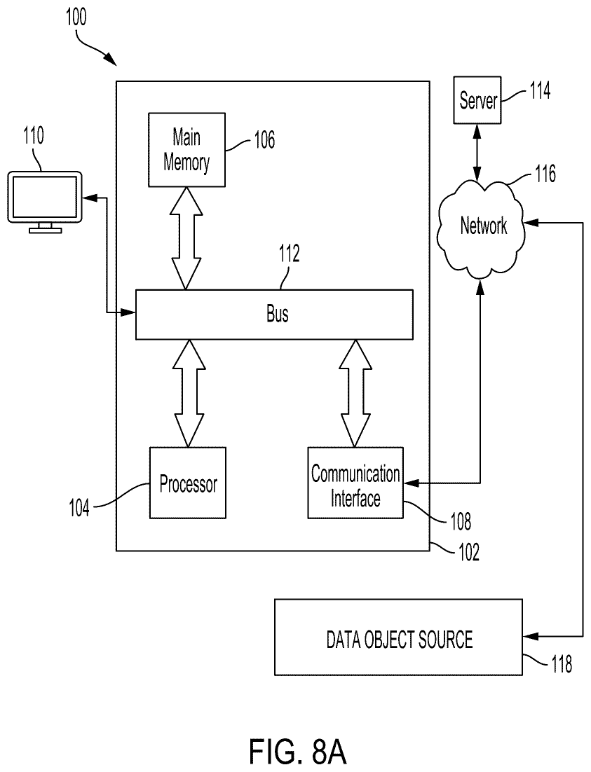

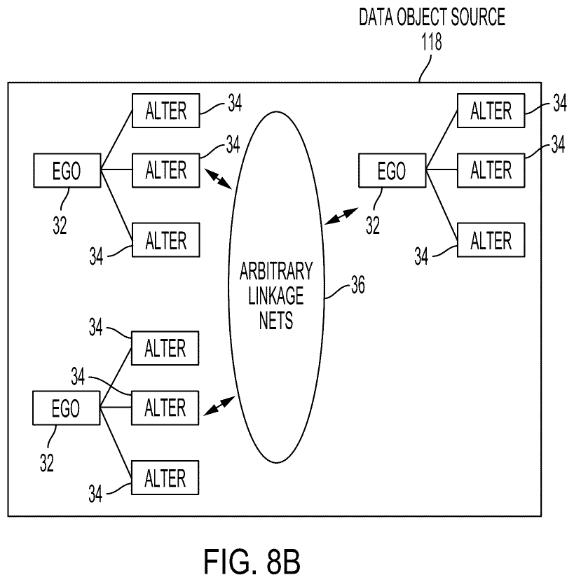

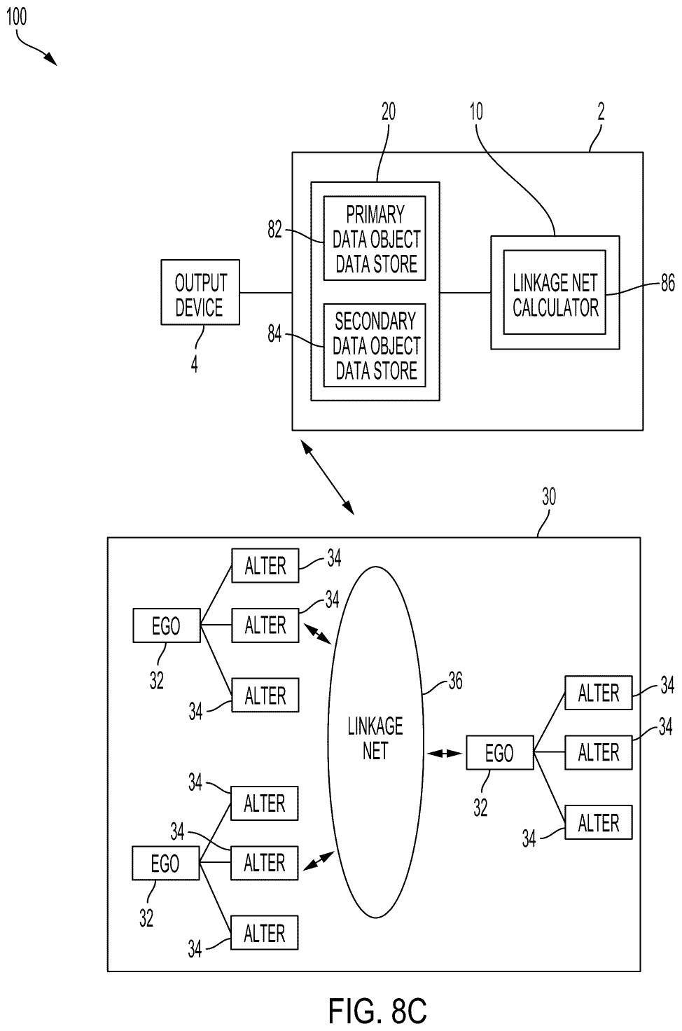

To restate the preceding, but with reference to various particular aspects of the data objects of the system implemented herein, in various embodiments, the system and methods solves particular problems relating to the mapping of data objects and the ascertainment of cause and effect among multiple data objects. For instance, a focal individual (ego) may be a primary data object and a connected counterpart individual (alter) may be a secondary data object. Multiple secondary data objects may be connected to a primary data object via a primary-to-secondary-object net. A secondary data object may be connected to multiple primary data objects via the primary-to-secondary-object net. A secondary data object may also be connected to one or more other secondary data object via a secondary-to-secondary object net. FIG. 8B illustrates these relationships with egos 32 as primary data objects, alters 34 as secondary data objects and an arbitrary linkage nets 36 corresponding to the primary-to-secondary-object net and the secondary-to-secondary object net. This data may be stored in a data object source 118, which will be discussed in greater detail below.

Thus an input to a function of the primary data object may have both an effect on the primary data object, such as generating a function output (direct treatment effect), but the input may also propagate to and affect one or more secondary data object having a function. This propagated input may then cause a secondary object function output (indirect treatment effect) at the secondary object. Because of noise introduced by the primary-to-secondary-object net and also because of the transformation of inputs to output effectuated by the primary data object generating the function output, the secondary objects may produce secondary object function outputs that have unexpected values. Moreover, secondary-to-secondary object nets may introduce further unexpected values, further changing the value of a secondary object function output. Thus, while reference is made to individuals herein, one may appreciate that the system is operative on data objects which may have functions that represent certain behaviors.

The preceding discussion proposes a novel representative sampling algorithm tailored for peer encouragement designs. The approach uses a Metropolis-Hasting algorithm to optimize the distribution of network properties in the sample according to that in the population network, thereby mitigating underrepresentation. Moreover, by incorporating customized distance constraints between the sampled ego-networks, the method guarantees a predetermined large sample size, alleviating issues of undersupply.

An important innovation of the system and method lies in its ability to generate ego-network samples by simultaneously tackling the underrepresentation and undersupply issues. The prior discussion benchmarks the state-of-the-art approaches, explains large scale of simulation studies, and demonstrates that samples obtained from the disclosed method offer several advantages: (1) it improves the representativeness of samples and guarantees large sample size; (2) it provides more accurate estimates of both average and heterogenous direct and indirect treatment effects; (3) it increases statistical power of testing the treatment effects. Practically, the method (1) is computationally efficient, (2) can be easily implemented in companies' experimentation platforms, and (3) is cost-effective.

Turning now to one example implementation of a system that performs the methods herein, attention is directed to FIG. 8A for an example computing system to perform the methods. In various embodiments, a system 100 is disclosed herein. The system 100 (e.g., a computing system) may include a computing apparatus 102. The computing apparatus 102 may include one or more processors 104, a memory 106 and/or a bus 112 and/or other mechanisms for communicating between the one or more processors 104 and other components. The system 100 may be a cloud computing system including processors, servers, storage, databases, networking, software, analytics, and/or intelligence accessed or performed over or using the Internet (“the cloud”). The one or more processors 104 may be implemented as a single processor or as multiple processors. The one or more processors 104 may execute instructions stored in the memory 106 to implement the applications and/or detection of the system 100.

The one or more processors 104 may be coupled to the memory 106. The memory 106 may include one or more of a Random Access Memory (RAM) or other volatile or non-volatile memory. The memory 106 may be a non-transitory memory or a data storage device, such as a hard disk drive, a solid-state disk drive, a hybrid disk drive, or other appropriate data storage, and may further store machine-readable instructions, which may be loaded and executed by the one or more processors 104.

The memory 106 may include one or more of random-access memory (“RAM”), static memory, cache, flash memory and any other suitable type of storage device or computer readable storage medium, which is used for storing instructions to be executed by the one or more processors 104. The storage device or the computer readable storage medium may be a read only memory (“ROM”), flash memory, and/or memory card, which may be coupled to a bus 112 or other communication mechanism. The storage device may be a mass storage device, such as a magnetic disk, optical disk, and/or flash disk that may be directly or indirectly, temporarily, or semi-permanently coupled to the bus 112 or other communication mechanism and be electrically coupled to some or all the other components within the system 100 including the memory 106, the user interface 110 and/or the communications interface 108 via the bus 112.

The term “computer-readable medium” is used to define any medium that can store and provide instructions and other data to a processor, particularly where the instructions are to be executed by a processor and/or other peripheral of the processing system. Such medium can include non-volatile storage, volatile storage, and transmission media. Non-volatile storage may be embodied on media such as optical or magnetic disks. Storage may be provided locally and in physical proximity to a processor or remotely, typically by use of network connection. Non-volatile storage may be removable from computing system, as in storage or memory cards or sticks that can be easily connected or disconnected from a computer using a standard interface.

The system 100 may include a user interface 110. The user interface 110 may include an input/output device. The input/output device may receive user input, such as a user interface element, hand-held controller that provides tactile/proprioceptive feedback, a button, a dial, a microphone, a keyboard, or a touch screen, and/or provides output, such as a display, a speaker, an audio and/or visual indicator, or a refreshable braille display. The display may be a computer display, a tablet display, a mobile phone display, an augmented reality display or a virtual reality headset. The display may output or provide data related to egos and alters and relationships among egos and alters.

The user interface 110 may include an input/output device that receives user input, such as a user interface element, a button, a dial, a microphone, a keyboard, or a touch screen, and/or provides output, such as a display, a speaker, headphones, an audio and/or visual indicator, a device that provides tactile/proprioceptive feedback or a refreshable braille display. The user interface 110 may receive user input that may include configuration settings for one or more user preferences.

The system 100 may have a network 116 connected to a server 114. The network 116 may be a local area network (LAN), a wide area network (WAN), a cellular network, the Internet, or combination thereof, that connects, couples and/or otherwise communicates between the various components of the system 100 with the server 114. The server 114 may be a remote computing device or system that includes a memory, a processor and/or a network access device coupled together via a bus. The server 114 may be a computer in a network that is used to provide services, such as accessing files or sharing peripherals, to other computers in the network.

The system 100 may include a communications interface 108, such as a network access device. The communications interface 108 may include a communication port or channel, such as one or more of a Dedicated Short-Range Communication (DSRC) unit, a Wi-Fi unit, a Bluetooth® unit, a radio frequency identification (RFID) tag or reader, or a cellular network unit for accessing a cellular network (such as 3G, 4G or 5G). The communication interface may transmit data to and receive data from the different components.

The server 114 may include a database. A database is any collection of pieces of information that is organized for search and retrieval, such as by a computer, and the database may be organized in tables, schemas, queries, reports, or any other data structures. A database may use any number of database management systems. The information may include real-time information, periodically updated information, or user-inputted information.

In various embodiments, the system 100 further comprises a data object source 118. The data object source 118 may comprise a computer, a memory, or another device that is connected via the network 116 to the computing apparatus 102 and provides data thereto. This data can include data corresponding to egos and/or alters. Thus, this data includes primary object data and/or secondary object data. As discussed further herein, egos may be represented by data objects. A data object is a structured collection of data having values and fields. Similarly, alters may be represented by data objects. Egos may be represented by primary data objects made of primary object data and alters may be represented by secondary data objects made of secondary object data. There may be connections among the data objects, such as may illustrate the causes and effects modeled herein. The system may identify and characterize these connections in a so-called net, which is discussed further herein.

Referring now to FIGS. 8B and 8C, an illustration of the contents of a data object source 118 is provided. As mentioned, the data object source may include data corresponding to egos 32 and alters 34. There may be linkages among egos and alters 34 illustrated by lines. These linkages may also be an aspect of an arbitrary linkage net 36. The arbitrary linkage net 36 may comprise data representative of connections between an ego 32 and multiple alters 34. The arbitrary linkage net 36 may comprise data representative of connections between different egos 32. The arbitrary linkage net 36 may comprise data representative of connections between different alters 34. The arbitrary linkage net 36 may comprise data representative of connections between different clusters of ego 32 and alters 34.

The arbitrary linkage nets 36 may be the cause-effect relationships discovered and/or modeled by the methods herein. For instance, an input to a primary data object (ego) may cause an output, but in addition to being directly output, may influence or cause an input to a secondary data object (alter). These complex input and output relationships induce non-linearities and multi-causal relationships that are modeled by the arbitrary linkage nets 36. In addition to connections among and between egos 32 and alters 34, the arbitrary linkage nets 36 may also include transfer functions that characterize the connections.

Referring now to FIG. 8C, another block representation of the system 100 is illustrated as logical modules. For instance, an analytics system 2 is provided. The analytics system 2 may connect to an output device 4 for human-machine interaction. This may be the user interface 110 of FIG. 8B. A processor 10 is illustrated. This may be processor 104 (FIG. 8A). A memory 20 is illustrated. This may be the main memory 106 (FIG. 8A), the data object source 118 (FIG. 8A), or aspects of the server 114 (FIG. 8A) and/or a combination thereof. Similarly, the data object source 30 (FIGS. 8B-8C) may be the data object source 118 (FIG. 8A).

The processor 10 may include a linkage net calculator 86. The linkage net calculator 86 is a logical unit that performs the methods provided herein and determines the linkage net 36. The memory 20 may include a primary data object data store 82 and a secondary data object data store 84. The primary data object data store 82 may include data representing egos 32 (primary data objects). The secondary data object data store 84 may include data representing alters 34 (secondary data objects). While separately represented, these two data object data stores may be a part of a same memory, in various embodiments.

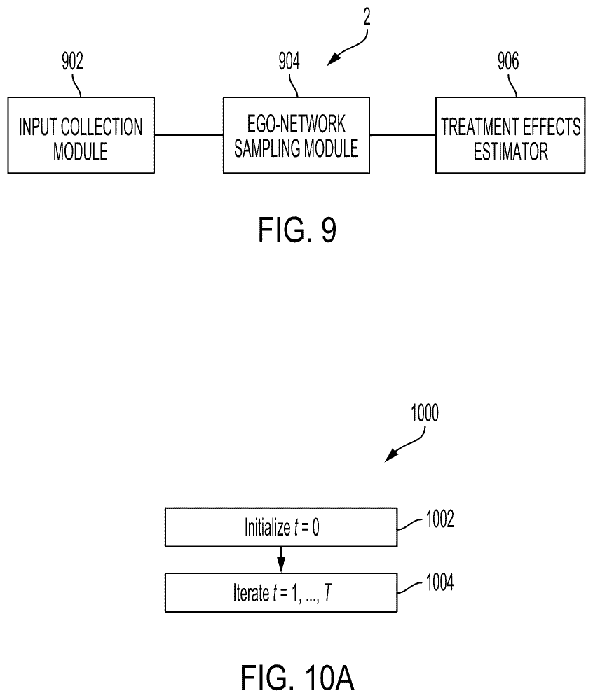

The linkage net calculator 86 may be conceptualized as three modules. For instance, turning to FIG. 9, there may be three modules that perform different aspects of the method herein. Many important innovations may be in the ego-network sampling module 904. The logical illustration of different modules may be conceptualized in different ways as well. For instance, a logical analytics system 2 may be implemented in an analytics system 2 of FIG. 8C as logical aspects of the analytics system 2. Thus, the analytics system 2 may include an input collection module 902, an ego-network sampling module 904, and a treatment effects estimator 906. These may be logical aspects of a device and/or method instantiated in the processor 10 (FIG. 8C) and memory 20 (FIG. 8C) of the analytics system 2. All or part of these aspects may be components or operating inside the components of the system 100 shown in FIG. 8A.

With detailed reference to the input collection module 902, the input collection module 902 may implement various processes, method aspects, or features. For instance, an input for implementing the method may be collected.

The input may include population network information. The method requires certain population network information as input, including the nodes and links in population network G, and the distribution of network properties f (e.g., degree, clustering coefficient, and eigen centrality) denoted by f(G).

The input may include experiment condition information. The method may require certain experiment information as input, including treatment conditions D, and the desired sample sizes n_{d} for each treatment condition d∈D.

Turning to the ego-network sampling module 904, a proposed Metropolis-Hastings ego-network sampling algorithm may be used. The module may be set up the objective function of the optimization problem. The method aims to optimize (minimize) the objective function Δ(f(S_{d}), f(G)), which represents the distance between the distributions of network properties f (e.g., degree and clustering coefficient) in the sampled egos S_{d} and in the population G. The optimization procedure ensures the representativeness of the obtained ego-network samples

$$arg {min}_{{S}_{d} ⊆ G} Δ ( f ( {S}_{d} ) , f ( G ) ) . \qquad ( 11 )$$

The objective function requires a measure to quantify the distance between the population and sample distributions of network properties f. The method allows for a flexible choice of the distance measure, such as Kullback-Leibler divergence, Anderson-Darling Statistics, and Kolmogorov-Smirnov (KS) Statistics. For illustrative purpose, the discussion uses the KS-Statistics which corresponds to the maximum absolute difference between the two cumulative distribution functions F_{G} of f(G) and F_{S}_{_{d}} of f(S_{d}).

The ego-network sampling module 904 may set up the constraint(s) of the optimization problem. The method controls for the treatment contamination by adding constraint(s) to the objective function regarding the network distance between ego-networks. Depending on the potential contaminations, one can set up the constraint to eliminate either first-degree and/or second-degree contamination between any two sampled egos subject to i∉A(i′) and/or A(i)∪A(i′)=∅, for i, i′∈S_{D}, and i≠i′.

The Metropolis-Hasting ego-network sampling used to generate representative samples that solve the optimization problem is also provided. The method innovatively solves the aforementioned constraint optimization problem by utilizing and adapting the Metropolis-Hasting algorithm for ego-network sampling. There are at least two aspects.

First, the target distribution of MH is designed based on the objective function. The sampling method draws egos S from the sample space [symbol] following a desired probability P(S) (e.g., a target distribution) such that samples S that are representative of the population should be drawn more frequently than those are not. Approximate P(S) by π(S) which is defined as the inverse of the distance measure and add a large positive scalar to reward high-quality samples.

Second, the MH algorithm is adapted to ego-network sampling in three key aspects: (1) consider ego-networks (an ego and the corresponding alters) as sampling unit, (2) define a restricted candidate set C(Sᵣ) for generating new ego sample according to the constraint(s), (3) incorporates treatment conditions in the sampling procedure to ensure sample balance.

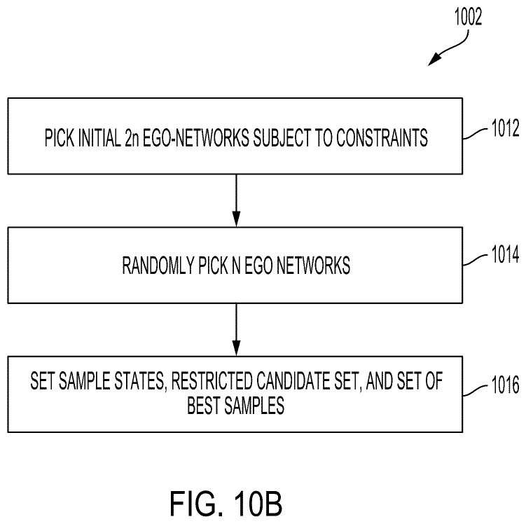

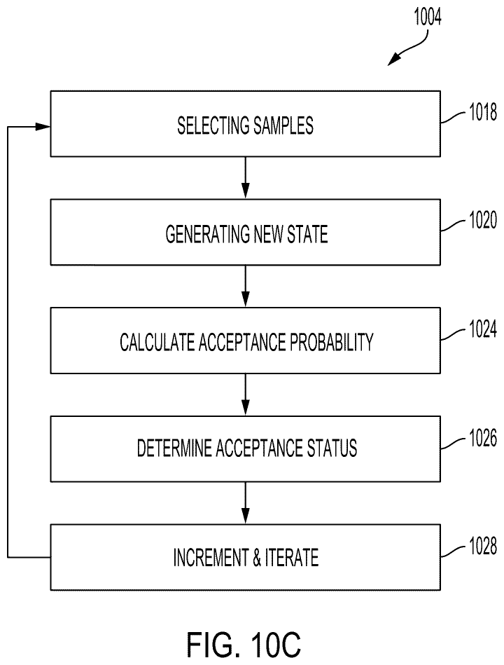

Referring to FIGS. 10A-10C, in various embodiments, the algorithm to implement the previous steps proceeds as follows below. The method may include an initialization stage (block 1002) and an iteration stage (block 1004). Within the initialization stage, there may be aspects such as to pick 2n ego-networks from G subject to the constraints as Sᵢₙᵢₜᵢₐₗ (block 1012). The method may include to randomly pick n ego-networks from Sᵢₙᵢₜᵢₐₗ for treatment condition T and the rest n ego networks for condition C (block 1014). The method may include to set sample states as {S_{C}^{t},S_{T}^{t}}, the restricted candidate set as C(S_{d}_{ᵣ}^{t}), the set of best samples as {S_{C}^{best},S_{T}^{best}} and t=0 (block 1016).

With initialization complete, the method moves on to the iteration stage (block 1004). The iteration stage may proceed for t=1, . . . , T. The iteration stage may include selecting samples (block 1018). Specifically, selecting samples may include selecting sample S_{d}^{t} for treatment condition d=T (if g=1) or d=C (if g=0) to be updated according to the Bernoulli random number g˜Ber(p).

The iteration stage may include generating a new state (block 1020). Specifically, generating a new state may include generating a new state S_{d}′ by swapping an ego in the current state S_{d}^{t} and a node in the restricted candidate set C(S_{d}_{ᵣ}^{t}) according to the proposal distribution q(S_{d}′|S_{d}^{t}).

The iteration stage may include calculating an acceptance probability (block 1024). Specifically, calculating an acceptance probability may include calculating the acceptance probability a(S_{d}′, S_{d}^{t}).

The iteration stage may include determining an acceptance status (block 1026). Specifically, determining an acceptance status may include (1) generating a uniform random number α∈[0,1]; (2) If α≤a(S_{d}′,S_{d}^{t}), then accept the new state and (A) updating the sample state S_{d}^{t+1}=S_{d}′ and updating the restricted candidate set C(S_{d}_{ᵣ}^{t+1}); (B) If Δ(f_{1,2}(S_{d}′), f_{1,2}(G))<Δ(f_{1,2}(S_{d}^{best}), f_{1,2}(G)), then update the best sample S_{d}^{best}=S_{d}′. If α>a(S_{d}′, S_{d}^{t}), then reject the new state and set S_{d}^{t+1}=S_{d}^{t}.

Finally, the iteration stage may include incrementing and iterating (block 1028). For instance, incrementing may include set t=t+1 iterating may include repeating for the new value of t.

With reference again to FIG. 9 and with detailed reference to the treatment effects estimator 906, the treatment effects estimator 906 may implement various processes, method aspects, or features. For instance, the obtained representative samples may be used to estimate the treatment effects. The ego-network samples derived from the method can be directly used by experimenters to estimate a variety of causal effects. For instance, one can estimate the average direct treatment effects by comparing the responses of egos and average indirect treatment effect by the responses of alters across treatment conditions. Experimenters can also investigate the heterogeneous direct and indirect treatment effects across subgroups of egos and alters by conducting statistical analyses directly using our samples.

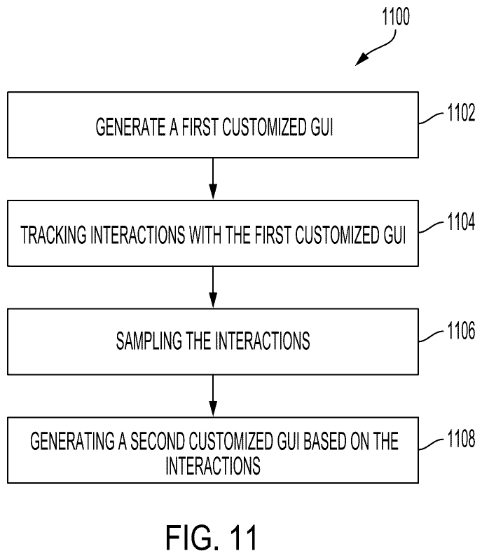

Referring now to FIG. 11, the preceding systems and methods may be implemented in a graphical interface of a computing system with a processing method 1100. The method may operate with a first customized GUI being generated, then interactions with the first customized GUI by egos being tracked, these tracked interactions then being sampled, and based on the sampling, a second customized GUI being generated based on the interactions. The first customized GUI may illustrate inputs provided to the egos, and the interactions may then be an aspect of a complex multi-causal net, so that the second customized GUI illustrates outputs provided by alters who were influenced by the egos. Thus, one may appreciate that this disclosure provides a system comprising one or more non-transitory computer-readable storage devices configured to store computing instructions configured to run on one or more processors and store interactions with a first customized GUI. This disclosure provides a system including one or more processors configured to run the computing instructions. The one or more processors perform generating the first customized GUI (block 1102), tracking the interactions with the first customized GUI (block 1104), sampling the interactions (block 1106), and generating a second customized GUI based on the sampling (block 1108).

The tracking the interactions may comprise tracking views of the first customized GUI or shares of the first customized GUI on a social network. The sampling the interactions may comprise using a predictive algorithm to sample the interactions. The using the predictive algorithm may comprise generating a Markov chain of interactions. The using the predictive algorithm may comprise implementing a Bayesian sampling algorithm. The predictive algorithm may comprise a Metropolis-Hastings algorithm. The sampling the interactions may comprise generating noncontaminated treatment samples and noncontaminated control samples. The noncontaminated treatment samples and the noncontaminated control samples may have no first-degree contamination and/or no second-degree contamination.

The one or more processors may be further configured to perform, after the tracking the interactions, generating an ego network using the interactions. The sampling the interactions may include sampling ego networks from the population network. The generating the first custom GUI may include generating a customized social media website for a plurality of users.

Stated differently, and with continuing reference to FIG. 11, a method 1100 is provided of quantifying heterogenous direct effects of data input and output relationships among data objects. The method may be performed by a system comprising (i) one or more non-transitory computer-readable storage devices configured to store computing instructions configured to run on one or more processors and store interactions with a first customized GUI. The system may include (ii) one or more processors configured to run the computing instructions, the one or more processors performing the method. The method may include generating the first customized GUI including data objects comprising the data input (block 1102). The method may include tracking the interactions with the first customized GUI (block 1104). The method may include sampling the interactions (block 1106). The method may include generating a second customized GUI based on the sampling (block 1108). The second customized GUI comprises further data objects. The further data objects correspond to the direct effects.

Turning now to the combination of FIGS. 1-11, but with particular reference to FIGS. 8A-10C, an analytics system 2 is discussed in reference to particular example embodiments. The system 2 may be an electronic system to determine relationships between electronic data objects. The system 2 may include a primary data object data store 82 storing a primary data object and a secondary data object data store 84 storing a secondary data object. The primary data object comprises a function having a primary data object input and a primary data object output. The secondary data object comprises a secondary function having a secondary data object input and a secondary data object output. The system 2 includes a linkage net calculator 86 configured to measure an effect on a secondary data object output value of at least one secondary data object responsive to at least one of a primary data object value of a primary data object or a change in the primary data object value of a primary data object. The linkage net calculator 86 may generate a linkage net 36 comprising a linkage data object with values corresponding to identified effects and corresponding one or more secondary data objects and corresponding one or more primary data objects corresponding to the identified effects.

In various embodiments, the linkage net comprises (1) a field identifying the primary data object having the primary data object input that has an effect on the secondary data object output and (2) a function characterizing the effect. The system 2 may comprise, within the linkage net calculator 86, a secondary data object linkage net calculator configured to measure an effect on (x) a further secondary data object output value of at least one further secondary data object (y) responsive to at least one of the secondary data object value of the secondary data object or a change in the secondary data object value of the secondary data object. The secondary data object linkage net calculator may generate a secondary data object linkage net (within the linkage net 36) comprising a secondary linkage data object with values corresponding to identified effects and corresponding to one or more secondary data objects and corresponding one or more further secondary data objects corresponding to the identified effects.

In various embodiments, the primary data object data store 82 comprises a computer memory 20, the secondary data object data store 84 comprises a computer memory 20, and the linkage net calculator 86 comprises a processor 10.

The primary data object may be a data object corresponding to an internet account publishing at least one of text and photos to a website, such as a social media website. The secondary data object may be a data object corresponding to another internet account publishing at least one of text and photos in responsive to the primary data object. The primary data object input may be text or images present on the internet. The secondary data object input may be text or images output onto the internet by the primary data object. The secondary data object output may be text or images output by the secondary data object on the internet. In various embodiments, the primary data object store is a repository of primary data object corresponding to accounts publishing content on the internet. In various embodiments, the secondary data object store is a repository of data objects corresponding to accounts accessing the published content on the internet published by the primary data objects. Moreover, in various embodiments, the linkage net calculator is a processor running a predictive algorithm comprising a Metropolis-Hastings algorithm, to measure the effect.

Stated another way, a linkage display object is provided. The linkage display object may be structured to generate a human-readable screen display image for viewing on a human-readable screen display. The human-readable screen display image may have visual elements corresponding to values of the linkage display object. The linkage display object may include a linkage net calculator. The linkage net calculator may be configured to perform various tasks.

For instance, the linkage net calculator may (i) measure an effect on a secondary data object output value of at least one secondary data object responsive to at least one of a primary data object value of a primary data object or a change in the primary data object value of the primary data object. The primary data object includes a function having a primary data object input and a primary data object output. The secondary data object includes a secondary function having a secondary data object input and a secondary data object output.

The linkage net calculator may (ii) generate a linkage net including the linkage data object with values corresponding to identified effects corresponding to one or more secondary data objects and one or more primary data objects.

In various instances, the disclosed system and method has different applications. For instance, the proposed representative sampling algorithm holds promise for widespread application in evaluating targeted marketing campaigns in social networks and analyzing social influences. Its adaptability and computational efficiency make it suitable for integration into diverse network experimentation platforms.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not for purposes of limitation.

For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise. For example, the description or claims may refer to a processor for convenience, but the invention and claim scope contemplates that the processor may be multiple processors. The multiple processors may handle separate tasks or combine to handle certain tasks. Although specific advantages have been enumerated herein, various embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The system may allow users and/or electronic devices (collectively, “users”) to access data, and receive updated data in real time from other users. The system may store the data (e.g., in a standardized format) in a plurality of storage devices, provide remote access over a network so that users may update the data in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system allows remote users to share data in real time in a standardized format, regardless of the format (e.g. non-standardized) that the information was input by the user. The system may also include a filtering tool that is remote from the end user and provides customizable filtering features to each end user. The filtering tool may provide customizable filtering by filtering access to the data. The filtering tool may identify data or accounts that communicate with the server and may associate a request for content with the individual account, user, device, etc. The system may include a filter on a local computer and a filter on a server.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”) and/or a radio frequency (RF) communications protocol. In this regard, “electronic communication,” as used herein, includes wired and wireless communications (e.g., Bluetooth, Bluetooth LE, NFC, TCP/IP, Wi-Fi, etc.).

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, data may refer to partially or fully structured, semi-structured, or unstructured data sets including “big data”, which may include millions of rows and hundreds of thousands of columns.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, public and private keys, and/or the like.

As used herein, a “script” refers to instructions for a computing device to carry out one or more tasks automatically. As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, personal internet device, online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system may be described herein as being implemented with TCP/IP communications protocols, the system may also be implemented using IPX, APPLETALK®, IPv6, NetBIOS, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” or “cloud computing infrastructure” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. Reference to a “device” or processor or memory or the like may include cloud resources, non-cloud resources, or combinations of cloud and non-cloud resources.

Computer programs (also referred to as computer control logic) are stored in main memory and/or secondary memory. Computer programs may also be received via communications interface. These computer program instructions may be loaded onto a general purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

In various embodiments, components, modules, and/or engines of the systems may be implemented as applications or apps. Apps are typically deployed in the context of a mobile operating system, including for example, a WINDOWS® mobile operating system, an ANDROID® operating system, an APPLE® iOS operating system, a BLACKBERRY® company's operating system, and the like. The app may be configured to leverage the resources of the larger operating system and associated hardware via a set of predetermined rules which govern the operations of various operating systems and hardware resources. For example, where an app desires to communicate with a device or network other than the mobile device or mobile operating system, the app may leverage the communication protocol of the operating system and associated device hardware under the predetermined rules of the mobile operating system. Moreover, where the app desires an input from a user, the app may be configured to request a response from the operating system which monitors various hardware components and then communicates a detected input from the hardware to the app.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, and the descriptions thereof may make reference to user WINDOWS®/LINUX®/UNIX® applications, webpages, websites, web forms, prompts, etc. Practitioners will appreciate that the illustrated steps described herein may comprise, in any number of configurations, including the use of WINDOWS®/LINUX®/UNIX® applications, webpages, web forms, popup WINDOWS®/LINUX®/UNIX® applications, prompts, and the like. It should be further appreciated that the multiple steps as illustrated and described may be combined into single webpages and/or WINDOWS®/LINUX®/UNIX® applications but have been expanded for the sake of simplicity. In other cases, steps illustrated and described as single process steps may be separated into multiple webpages and/or WINDOWS®/LINUX®/UNIX® applications but have been combined for simplicity.

The computers discussed herein may provide a suitable website or other internet-based graphical user interface (GUI) which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PHP, Ruby, and/or PYTHON® programming languages.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system comprising:
one or more non-transitory computer-readable storage devices configured to:
store computing instructions configured to run on one or more processors; and
store interactions with a first customized GUI; and
one or more processors configured to run the computing instructions and perform:
generating the first customized GUI;
tracking the interactions with the first customized GUI;
sampling the interactions; and
generating a second customized GUI based on the sampling.

2. The system of claim 1, wherein the tracking the interactions comprises tracking views of the first customized GUI or shares of the first customized GUI on a social network.

3. The system of claim 1, wherein the sampling the interactions comprises using a predictive algorithm to sample the interactions.

4. The system of claim 3, wherein the using the predictive algorithm comprises generating a Markov chain of interactions.

5. The system of claim 3, wherein the using the predictive algorithm comprises implementing a Bayesian sampling algorithm.

6. The system of claim 3, wherein the predictive algorithm comprises a Metropolis-Hastings algorithm.

7. The system of claim 1, wherein the sampling the interactions comprises generating noncontaminated treatment samples and noncontaminated control samples.

8. The system of claim 7, wherein the noncontaminated treatment samples and the noncontaminated control samples have no first-degree contamination and no second-degree contamination.

9. The system of claim 1, wherein:
the one or more processors are further configured to perform, after the tracking the interactions, generating an ego network using the interactions; and
the sampling the interactions comprises sampling representative ego networks from the population network.

10. The system of claim 1, wherein the generating the first custom GUI comprises generating a customized social media website for a plurality of users.

11. A system to determine relationships between electronic data objects, the system comprising:
a primary data object data store;
a secondary data object data store,
wherein the primary data object comprises a function having a primary data object input and a primary data object output,
wherein the secondary data object comprises a secondary function having a secondary data object input and a secondary data object output; and
a linkage net calculator configured to:
measure an effect on a secondary data object output value of at least one secondary data object responsive to at least one of a primary data object value of a primary data object or a change in the primary data object value of a primary data object; and
generate a linkage net comprising a linkage data object with values corresponding to identified effects corresponding to one or more secondary data objects and one or more primary data objects.

12. The system according to claim 11, wherein the linkage net comprises (1) a field identifying the primary data object having the primary data object input that has an effect on the secondary data object output and (2) a function characterizing the effect.

13. The system according to claim 11, further comprising a secondary data object linkage net calculator configured to:
measure an effect on (x) a further secondary data object output value of at least one further secondary data object (y) responsive to at least one of the secondary data object value of the secondary data object or a change in the secondary data object value of the secondary data object; and
generate a secondary data object linkage net comprising a secondary linkage data object with values corresponding to identified effects and corresponding to one or more secondary data objects and one or more further secondary data objects.

14. The system according to claim 11,
wherein the primary data object data store comprises a computer memory,
wherein the secondary data object data store comprises the computer memory, and
wherein the linkage net calculator comprises a processor.

15. The system according to claim 11,
wherein the primary data object comprises a data object corresponding to an internet account publishing at least one of text and photos to a website, and
wherein the primary data object comprises a data object corresponding to another internet account publishing at least one of text and photos in responsive to the primary data object.

16. The system according to claim 12,
wherein the primary data object input comprises text or images present on the internet,
wherein the secondary data object input comprises text or images output onto the internet by the primary data object, and
wherein the secondary data object output comprises text or images output by the secondary data object on the internet.

17. The system according to claim 11, wherein the primary data object store comprises a repository of primary data objects corresponding to accounts publishing content on the internet.

18. The system according to claim 17, wherein the secondary data object store comprises a repository of data objects corresponding to accounts accessing the published content on the internet published by the primary data objects.

19. The system according to claim 11, wherein the linkage net calculator comprises a processor running a predictive algorithm comprising a Metropolis-Hastings algorithm, to measure the effect.

20. A method of quantifying heterogenous effects of data input and output relationships among data objects by a system, the system comprising (i) one or more non-transitory computer-readable storage devices configured to store computing instructions configured to run on one or more processors and store interactions with a first customized GUI, and (ii) one or more processors configured to run the computing instructions, the one or more processors performing the method, the method comprising:
generating the first customized GUI including data objects comprising the data input;
tracking the interactions with the first customized GUI;
sampling the interactions; and
generating a second customized GUI based on the sampling,
wherein the second customized GUI comprises further data objects, and
wherein the further data objects correspond to the effects.

21. A linkage display object structured to generate a human-readable screen display image for viewing on a human-readable screen display, the human-readable screen display image having visual elements corresponding to values of the linkage display object, wherein the linkage display object comprises:
a linkage net calculator configured to:
(i) measure an effect on a secondary data object output value of at least one secondary data object responsive to at least one of a primary data object value of a primary data object or a change in the primary data object value of the primary data object,
wherein the primary data object comprises a function having a primary data object input and a primary data object output, and
wherein the secondary data object comprises a secondary function having a secondary data object input and a secondary data object output; and
(ii) generate a linkage net comprising the linkage data object with values corresponding to identified effects corresponding to one or more secondary data objects and one or more primary data objects.
